(19) United States
(12) Patent Application Publication
(10) Pub. No.: US 2025/0212127 A1
(43) Pub. Date: Jun. 26, 2025

(54) ENHANCED POWER CONTROL

(71) Applicant: InterDigital Patent Holdings, Inc., Wilmington, DE (US)

(72) Inventors: Patrick Svedman, Stockholm (SE); Arman Shojaeifard, London (GB); Allan Yingming Tsai, Boonton, NJ (US); Kyle Jung-Lin Pan, Saint James, NY (US); Guodong Zhang, Woodbury, NY (US)

(73) Assignee: InterDigital Patent Holdings, Inc., Wilmington, DE (US)

(21) Appl. No.: 18/852,987

(22) PCT Filed: Apr. 4, 2023
(86) PCT No.: PCT/US2023/017379

§ 371 Date: Sep. 30, 2024

Related U.S. Application Data
(60) Provisional application No. 63/329,171, filed on Apr. 8, 2022.

(51) Int. Cl. H04W 52/10; H04B 17/318; H04W 52/02; H04W 52/24; H04W 72/231

(52) U.S. Cl. CPC H04W 52/10; H04B 17/328; H04W 52/0245; H04W 52/242; H04W 72/231

(57) ABSTRACT

Open loop power control may be based on an estimated pathloss. A set of transmission and reception points (TRPs) may provide a set of reference signals (RSs) to a reference point (RP). The RP, and/or the RP in conjunction with a network with which the RP is associated, may determine a RSRP for each received RS (signature of RSRPs). A WTRU may be configured with the signature of RSRPs. The TRP may provide the set of RSs to the WTRU. The WTRU may determine a set of RSRPs for the received RSs (RSRP_{WTRU}). The WTRU may determine a difference between the signature RSs and RSRP_{WTRU}. The WTRU may determine an estimated uplink pathloss associated with the WTRU and the RP based on the determined difference. The determined pathloss may be utilized in open-loop power control.

### CROSS REFERENCE TO RELATED APPLICATIONS

This application claims the benefit of U.S. Provisional Patent Application No. 63/329,171, filed Apr. 8, 2022. U.S. Provisional Application No. 63/329,171 is incorporated herein by reference in its entirety.

### BACKGROUND

Uplink power control may include open-loop and closed-loop power control. Typically, open-loop power control relies on the user equipment (UE), also referred to as a wireless transmit/receive unit (WTRU), measuring the received power of a downlink reference signal (DL RS) in order to estimate the pathloss. For devices that do not transmit a DL RS, however, existing open-loop power control mechanisms may not be applicable.

### SUMMARY

Enhanced open-loop power control schemes are described herein, based on the realization that reception points (RPs) as well as user equipments (UEs) (also referred to herein as wireless transmit/receive units, WTRUs) may estimate their position, e.g., based on a signature of reference signal received power (RSRP) of multiple pathloss reference signals (PL RSs) or other positioning technologies. Several enhancements for more flexible and efficient closed loop power control are described herein.

In various example embodiments involving a single transmission and reception point (TRP) and a single RP, the TRP may provide a reference signal (RS) to the RP. The RP, and/or the RP in conjunction with a network with which the RP is associated, may determine a reference signal received power (RSRP) for the received RS (RSRP_{RP}). A WTRU may be configured with the RSRP_{RP}. The TRP also may provide the RS to the WTRU. The WTRU may determine a RSRP for the received RS (RSRP_{WTRU}). The WTRU may determine a difference between RSRP_{RP} and RSRP_{WTRU}. The WTRU may determine an estimated uplink pathloss between the WTRU and the RP based on the determined difference. The difference may be close to zero when the WTRU is close to the RP, with small pathloss between WTRU and RP, and not close to zero when the WTRU is not close to the RP, with larger pathloss between WTRU and RP. The determined pathloss may be utilized in open-loop power control.

In various example embodiments, a set of TRPs may provide a set of reference signals (RSs) to a RP. The set of TRPs may comprise a single TRP or a plurality of TRPs. The set of RSs may comprise a single RS or a plurality of RSs. The RP, and/or the RP in conjunction with a network with which the RP is associated, may calculate a RSRP for each received RS. This set of RSRPs may be referred to as a signature of RSRPs. A WTRU may be configured with the signature of RSRPs. The TRP also may provide the set of RSs to the WTRU. The WTRU may determine a set of RSRPs for the received RSs (RSRP_{WTRU}). The WTRU may determine a difference between the signature RSs and RSRP_{WTRU}. The WTRU may determine an estimated uplink pathloss associated with the WTRU and the RP based on the determined difference. The determined pathloss may be utilized in open-loop power control.

An example method for performing enhanced power control may be performed by a WTRU. The method may include receiving configuration information. The configuration information may comprise a first set of reference signal received power (RSRP) values associated with a first set of received signals (RSs) measured at a reception point. The method may include measuring a second set of RSRP values associated with a second set of RSs, determining a difference between one or more of the first set of RSRP values and one or more of the second set of RSRP values, and determining a pathloss (PL) associated with open-loop (OL) power control (PC) based on the determined difference. The method may include transmitting an uplink transmission using a power level based on the determined PL. The method may include determining the power level based on the determined PL. The determined PL may comprise an estimated PL between the WTRU and the RP. The first set of RSRP values may comprise a first plurality of RSRP values, the second set of RSRP values may comprise a second plurality of RSRP values, and the first plurality may differ from the second plurality. The method may include receiving the second set of RSs from a plurality of transmission and reception points (TRPs). The method may include monitoring a subset of the first set of RSs associated with the received first set of RSRP values, wherein the second set of RSs comprises the subset of the first set of RSs. The method may include receiving an indication of the subset from at least one of downlink control information (DCI), a medium access channel control element (MAC CE), or a radio resource control (RRC) configuration. The method may include determining that the WTRU is co-located with the RP when the difference is zero. The method may include receiving at least one of the second set of RSs via a synchronization signal physical broadcast channel block (SSB), a channel state information reference signal (CSI-RS), a tracking RS (TRS), or a position RS (PRS). The method may include determining that the WTRU is in the vicinity of the reception point based on a predetermined threshold. The method may include determining the power level based on the WTRU being within a vicinity of the RP. The method may include receiving a power control parameter adjustment in response to the uplink transmission. The method may include reconfiguring an open loop power control configuration based on the received power control parameter adjustment. The first set of RSs and the second set of RSs may be associated with directional beams or wide beams. The configuration information may comprise a PL RS index for the uplink transmission, and the method may include determining that the PL RS index corresponds to a virtual PL RS.

An example WTRU configured to facilitate enhanced power control may comprise a processor and a transceiver. The WTRU may be configured to receive, via the transceiver, configuration information. The configuration information may comprise a first set of reference signal received power (RSRP) values associated with a first set of received signals (RSs) measured at a reception point. The WTRU may be configured to measure a second set of RSRP values associated with a second set of RSs, determine a difference between one or more of the first set of RSRP values and one or more of the second set of RSRP values, and determine a pathloss (PL) associated with open-loop (OL) power control (PC) based on the determined difference. The WTRU may be configured to transmit, via the transceiver, an uplink transmission using a power level based on the determined PL. The WTRU may be configured to determine the power level based on the determined PL. The determined PL may comprise an estimated PL between the WTRU and the RP. The first set of RSRP values may comprise a first plurality of RSRP values, the second set of RSRP values may comprise a second plurality of RSRP values, and the first plurality may differ from the second plurality. The WTRU may be configured to receive, via the transceiver, the second set of RSs from a plurality of transmission and reception points (TRPs). The WTRU may be configured to monitor, via the transceiver, a subset of the first set of RSs associated with the received first set of RSRP values, wherein the second set of RSs comprises the subset of the first set of RSs. The WTRU may be configured to receive, via the transceiver, an indication of the subset from at least one of downlink control information (DCI), a medium access channel control element (MAC CE), or a radio resource control (RRC) configuration. The WTRU may be configured to determine that the WTRU is co-located with the RP when the difference is zero. The WTRU may be configured to receive at least one of the second set of RSs via a synchronization signal physical broadcast channel block (SSB), a channel state information reference signal (CSI-RS), a tracking RS (TRS), or a position RS (PRS). The WTRU may be configured to determine that the WTRU is in the vicinity of the reception point based on a predetermined threshold. The WTRU may be configured to determine the power level based on the WTRU being within a vicinity of the RP. The WTRU may be configured to receive, via the transceiver, a power control parameter adjustment in response to the uplink transmission. The WTRU may be configured to reconfigure an open loop power control configuration based on the received power control parameter adjustment. The first set of RSs and the second set of RSs may be associated with directional beams or wide beams. The configuration information may comprise a PL RS index for the uplink transmission, and the WTRU may be configured to determine that the PL RS index corresponds to a virtual PL RS.

An example computer-readable storage medium may have executable instructions stored thereon that when executed by a processor, cause the processer to facilitate enhanced power control. When the executable instructions are executed, the processor may be configured to facilitate a WTRU to perform receive configuration information. The configuration information may comprise a first set of reference signal received power (RSRP) values associated with a first set of received signals (RSs) measured at a reception point. When the executable instructions are executed, the processor may be configured to facilitate a WTRU to measure a second set of RSRP values associated with a second set of RSs, determine a difference between one or more of the first set of RSRP values and one or more of the second set of RSRP values, and determine a pathloss (PL) associated with open-loop (OL) power control (PC) based on the determined difference. When the executable instructions are executed, the processor may be configured to facilitate a WTRU to transmit, via the transceiver, an uplink transmission using a power level based on the determined PL. When the executable instructions are executed, the processor may be configured to facilitate a WTRU to determine the power level based on the determined PL. The determined PL may comprise an estimated PL between the WTRU and the RP. The first set of RSRP values may comprise a first plurality of RSRP values, the second set of RSRP values may comprise a second plurality of RSRP values, and the first plurality may differ from the second plurality. When the executable instructions are executed, the processor may be configured to facilitate a WTRU to receive, via the transceiver, the second set of RSs from a plurality of transmission and reception points (TRPs). When the executable instructions are executed, the processor may be configured to facilitate a WTRU to monitor a subset of the first set of RSs associated with the received first set of RSRP values, wherein the second set of RSs comprises the subset of the first set of RSs. When the executable instructions are executed, the processor may be configured to facilitate a WTRU to receive an indication of the subset from at least one of downlink control information (DCI), a medium access channel control element (MAC CE), or a radio resource control (RRC) configuration. When the executable instructions are executed, the processor may be configured to facilitate a WTRU to determine that the WTRU is co-located with the RP when the difference is zero. When the executable instructions are executed, the processor may be configured to facilitate a WTRU to receive at least one of the second set of RSs via a synchronization signal physical broadcast channel block (SSB), a channel state information reference signal (CSI-RS), a tracking RS (TRS), or a position RS (PRS). When the executable instructions are executed, the processor may be configured to facilitate a WTRU to determine that the WTRU is in the vicinity of the reception point based on a predetermined threshold. When the executable instructions are executed, the processor may be configured to facilitate a WTRU to determine the power level based on the WTRU being within a vicinity of the RP. When the executable instructions are executed, the processor may be configured to facilitate a WTRU to receive, via the transceiver, a power control parameter adjustment in response to the uplink transmission. When the executable instructions are executed, the processor may be configured to facilitate a WTRU to reconfigure an open loop power control configuration based on the received power control parameter adjustment. The first set of RSs and the second set of RSs may be associated with directional beams or wide beams. The configuration information may comprise a PL RS index for the uplink transmission, and when the executable instructions are executed, the processor may be configured to facilitate a WTRU to determine that the PL RS index corresponds to a virtual PL RS.

Several abbreviations and acronyms are utilized throughout this Specification. Accordingly, to provide a better understanding of the herein described subject matter, a list of at least some of the abbreviations and acronyms is provided at the end of this Specification.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the figures and the detailed description are not to be considered limiting, and other equally effective examples are possible and likely. Like reference numerals (“ref” or “refs.”) in the Figures indicate like elements.

FIG. 1A is an example system diagram illustrating an example communications system in which one or more disclosed embodiments may be implemented.

FIG. 1B is an example system diagram illustrating an example wireless transmit/receive unit (WTRU) that may be used within the communications system illustrated in FIG. 1A according to an embodiment.

FIG. 1C is an example system diagram illustrating an example radio access network (RAN) and an example core network (CN) that may be used within the communications system illustrated in FIG. 1A according to an embodiment.

FIG. 1D is an example system diagram illustrating a further example RAN and a further example CN that may be used within the communications system illustrated in FIG. 1A according to an embodiment.

FIG. 2 is an example illustration of points in the context of transmission and reception points TRP(s) and/or RP(s).

FIG. 3 is an example illustration of two cells, with Cell A being served by multiple points and Cell B being served by a single TRP.

FIG. 4 is an example illustration of a cell with DL transmission in one TRP and UL reception in three points (one TRP and two RPs).

FIG. 5 is an example illustration of two cells, each served by multiple points.

FIG. 6 is an example illustration of a site serving two cells (Cell A and Cell B) at two frequency layers (f1 and f2).

FIG. 7 is an example illustration of transmit power control 1 (TPR1) serving Cell A on frequency layer f1 and reception point 1 (RP1) serving Cell B on frequency layer f2.

FIG. 8 is an example illustration of a configuration of pathloss (PL) reference signal (RS) pools for different channels/signals, configuration/activation/indication of three subsets of monitored PL RS.

FIG. 9 is an example illustration of reception point reference signal received power (RP RSRP) signature with wide/omni beams.

FIG. 10 is an example illustration of RP RSRP signature with directional beams.

FIG. 11 is a flow diagram of an example process for performing open loop power control.

FIG. 12 is an example illustration of a virtual PL RS configuration.

FIG. 13 is an example illustration of another virtual PL RS configuration.

FIG. 14 is a flow diagram of an example process for performing open loop power control.

FIG. 15 is an example depiction of a vicinity threshold.

FIG. 16 is a flow diagram of an example process for UL power control based on WTRU vicinity.

FIG. 17 is a flow diagram of another example process for UL power control based on WTRU vicinity.

FIG. 18 is an example illustration of interference-aware power control.

FIG. 19 is an example scenario comprising multiple WTRUs and multiple points.

FIG. 20 is another example scenario comprising multiple WTRUs and multiple points.

FIG. 21 is a flow diagram of an example process performed by a WTRU.

FIG. 22 is a flow diagram of another example process performed by a WTRU.

FIG. 23 is a flow diagram of another example process performed by a WTRU.

FIG. 24 a flow diagram of another example process performed by a WTRU.

### EXAMPLE NETWORKS FOR IMPLEMENTATION OF THE INVENTION

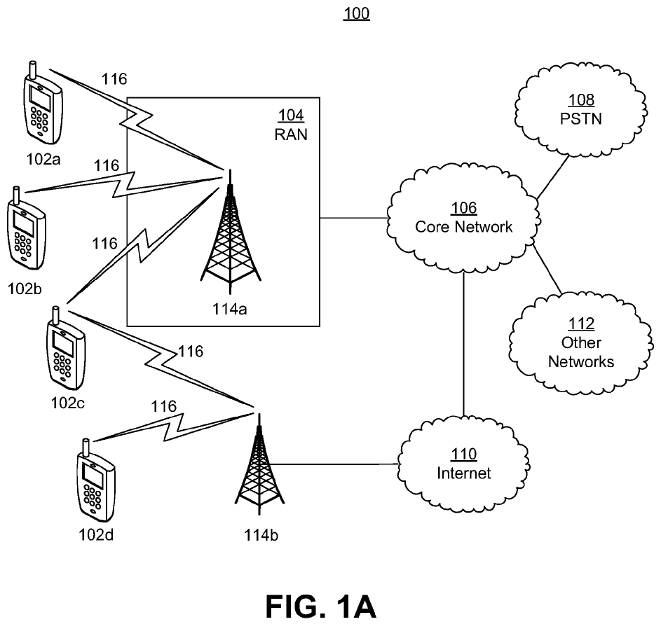

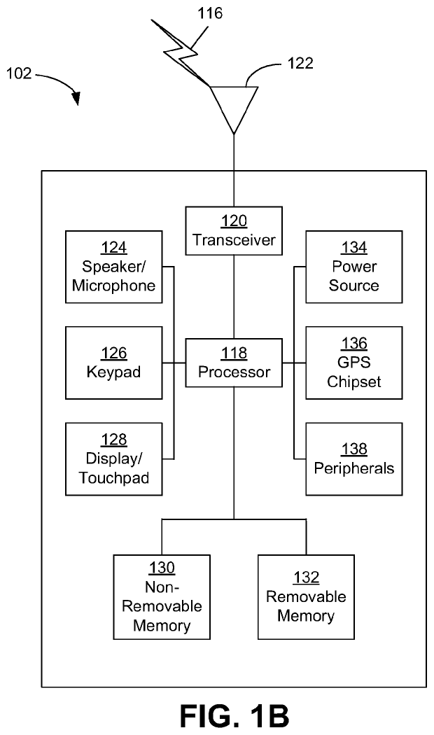

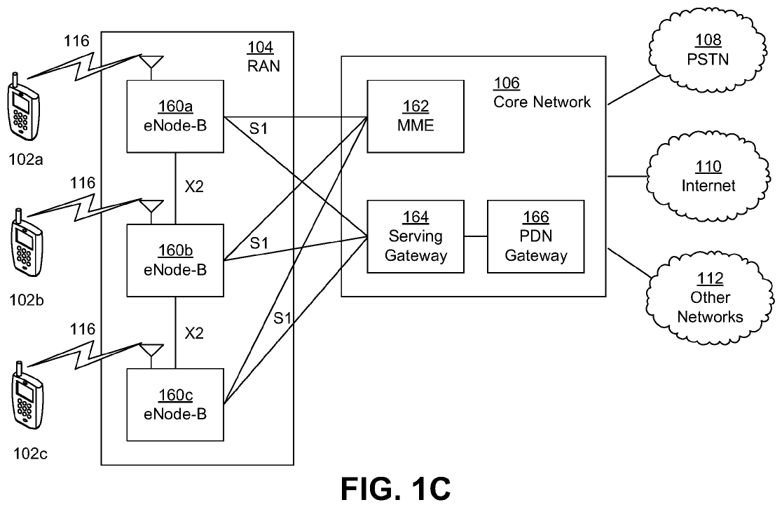

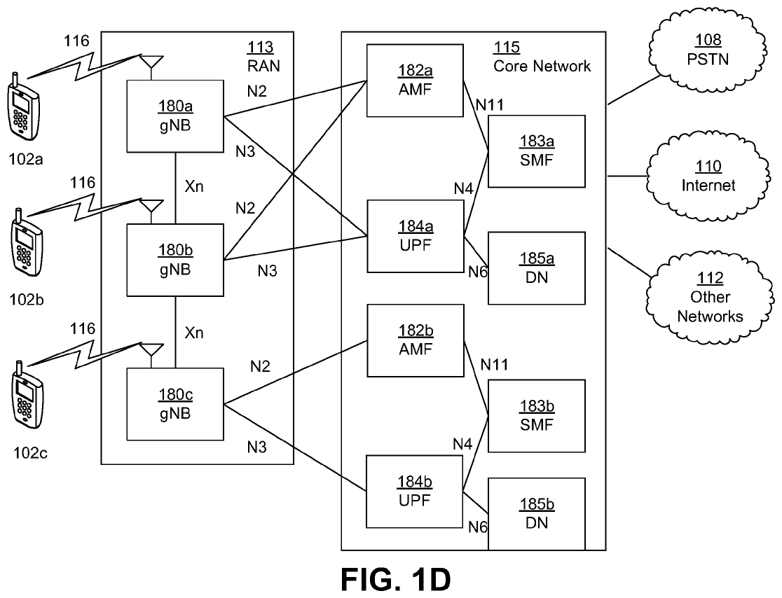

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMHI), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The ISS mode of communication may sometimes be referred to herein as an “ad-hoc” mode of communication.

When using the 802.1 lac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11 n, and 802.1 lac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11 ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Wireless communication between one or more user equipments (UEs) and a network are considered herein. A UE may also be referred to as a wireless transmit/receive unit (WTRU). The terms UE and WTRU are used interchangeably herein. The network, e.g., in the vicinity of a particular WTRU, may include transmission and reception points (TRPs) and/or reception points (RPs). TRPs/RPs may be called “distributed antenna system” (DAS), “remote radio head” (RRH), “access point” (AP), or distributed MIMO in various contexts.

A TRP may transmit signals and/or channels to one or more WTRUs, usually called the downlink (DL), and may receive signals and/or channels from one or more WTRUs, usually called the uplink (UL). In some cases, a TRP may act as a WTRU, e.g., when acting as a relay wherein the TRP may act as a WTRU and interact with another node to receive DL data which is then relayed to a WTRU, or wherein the TRP may act as a WTRU and relay UL data received from a WTRU to a base station.

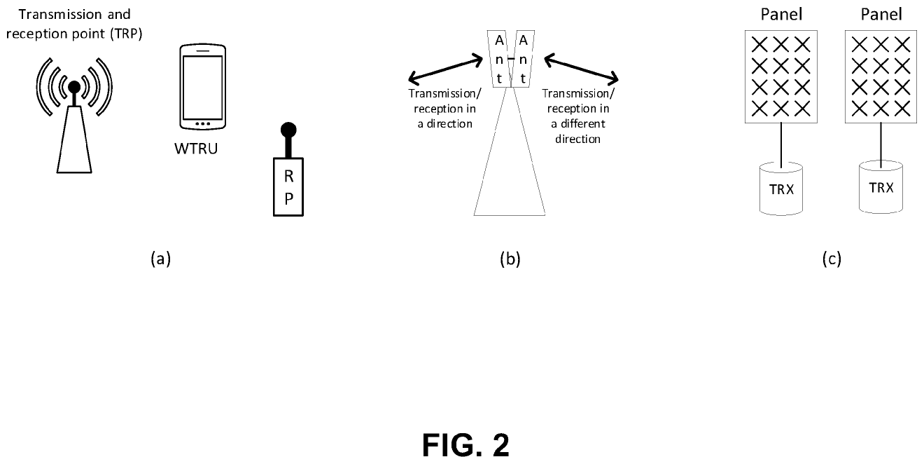

FIG. 2 is an example depiction of points in the context of TRP(s) and/or RP(s). An RP may receive signals and/or channels from one or more WTRUs (e.g., UL signals/channels). In the context of TRPs and RPs, different points may be geographically separated (see FIG. 2(a)). In some cases, different points may be located in approximately the same geographical location, but separated in some other way, for example the boresight(s) of the antenna(s) (or antenna element(s)) of a first point may be significantly different from the boresight(s) of the antenna(s) of a second point.

An example of the latter is cellular communication site serving multiple sectors in different directions, using different sets of antennas. In this case, the different sets of antennas serving different sectors in different directions from the site may be considered different points. This is illustrated in FIG. 2(b).

In some cases, antennas may be arranged in one or more panels, where a panel for example comprises a rectangular panel with N×M antenna elements, as illustrated in FIG. 2(c). In some cases, all, or a subset of the antenna elements of a panel may be connected to the same transmitter and receiver (TRX) chain or the same receiver (RX) chain. In some cases, antenna elements of different panels may be connected to different transmitter and receiver (TRX) chains or different receiver (RX) chains. In some cases, different panels, which may or may not be geographically co-located, may correspond to different points. In other cases, different panels may correspond to the same point.

In FIG. 2(a), there are two geographically separated points in the vicinity of a WTRU, a TRP and an RP. In FIG. 2(b), there are two TRPs in roughly the same geographical location in the form of two antennas (indicated by ‘Ant’ in the figure) mounted on the same site, but with main transmission/sensitivity directions (boresights) in significantly different directions. In FIG. 2(c), there are two panels, each associated with a point, each comprising a rectangular array of cross-polarized antenna elements (in the form of ‘X’s in the figure). Each panel is connected to a different TRX chain in this illustration.

In some cases, a point may operate on multiple frequencies, for example two frequencies. However, in some cases, a site (including for example one antenna, an antenna array, a panel, a subset of antennas per frequency) in a geographic location with a particular transmission/reception direction on the multiple frequencies may count as multiple points, at least from the point of view of a WTRU. One reason may be that the radio signal propagation properties on the different frequencies are different. Another reason may be that the hardware at the network side results in signal transmission and/or reception differences on the different frequencies, for example different oscillators, calibration hardware for beam correspondence, phase shifters for beamforming etc.

A signal/channel received at a TRP/RP may be subject to further processing, e.g., filtering, amplification, down-conversion, A/D conversion (sampling), digital signal processing, demodulation, channel decoding, etc. A signal/channel transmitted at a TRP may have been subject to various processing prior to transmission, e.g., filtering, amplification, peak-to-average power reduction, up-conversion, D/A conversion, digital signal processing, modulation, channel encoding, etc. A subset (e.g., none, some or all) of these operations for reception/transmission may be performed at the TRP/RP while other operations may be performed at one or more other location(s) connected with the TRP/RP, e.g., through a fronthaul or backhaul link, e.g., by optical fiber, copper wire, over-the-air. In a centralized RAN (CRAN) implementation, signal processing for multiple points is performed at a centralized location.

TRP(s) and RP(s) may operate on the same frequency layer. For example, in some scenarios, TRP(s) and/or RP(s) may operate on the same frequency layer, which may correspond to a carrier frequency and a bandwidth, a frequency band, or a range of frequencies. This may imply that a signal transmitted by a WTRU on the frequency layer may be received by these points (e.g., TRP(s) and/or RP(s)), at least if they are in the vicinity of the WTRU.

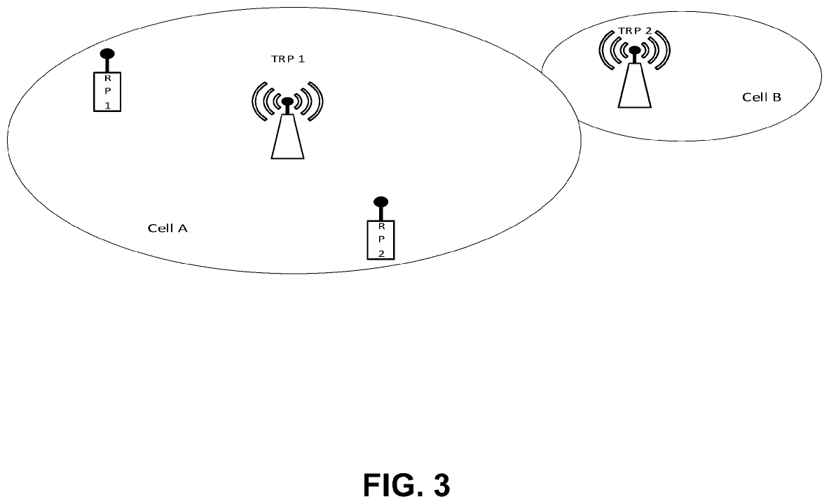

In a cellular system, a transmission and/or reception point may serve one or more cells on a frequency layer. A TRP serving a cell may imply that the TRP transmits signals associated with the cell, e.g., synchronization signal/physical broadcast channel blocks (SSB(s)), system information, etc. A transmission and/or reception point, e.g., an RP, serving a cell may imply that the point receives signals associated with the cell. In some cases, a transmission and/or reception point may serve a single cell on a frequency layer. In some cases, a transmission and/or reception point may serve multiple cells on a frequency layer. In some cases, a transmission and/or reception point may serve as a TRP for a first cell while serving as an RP for a second cell on the same frequency layer, as illustrated in FIG. 3. FIG. 3 is an example illustration of two cells, with Cell A being served by multiple points (RP1, RP2, TRP1) and Cell B being served by a single TRP (TRP2). In the example depicted in FIG. 3, TRP2 serves cell B as a TRP and serves cell A as an RP.

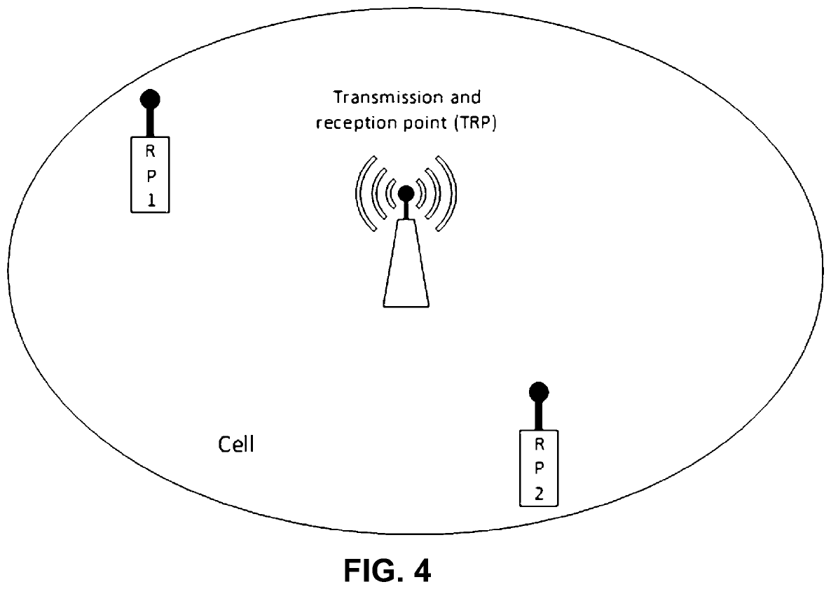

FIG. 4 depicts a cell with DL transmission in one TRP and UL reception in three points (one TRP and two RPs: RP1, RP2). In some cases, multiple transmission and/or reception points may serve a first cell, and in some cases one or more of these transmission and/or reception points also may serve a second cell on the same frequency layer. Multiple transmission and/or reception points serving a cell is illustrated in FIG. 4. As depicted in FIG. 4, the cell has more points receiving the UL (RP1, RP2, TRP) than points transmitting DL (TRP). This “UL dense deployment” may be beneficial for UL coverage and performance in the cell.

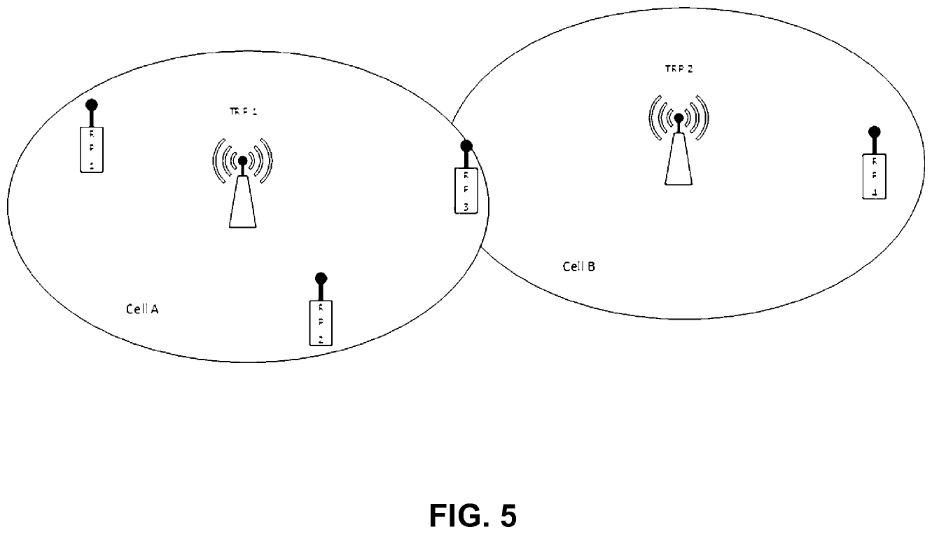

FIG. 5 is an example illustration of two cells (Cell A, Cell B), each served by multiple points. As depicted in FIG. 5, RP3 serves both cells. In FIG. 5, two nearby cells are illustrated, each served by multiple points. In this example, RP3 serves both Cell A and Cell B. UL transmissions from some WTRUs in Cell A as well as UL transmissions from WTRUs in Cell B may, at least occasionally, be received by RP3.

In some scenarios, TRP(s) and/or RP(s) may operate on different frequency layers or sets of frequency layers, which may be in the same or different frequency bands. A WTRU may be capable of being simultaneously served by cells on multiple different frequency layers, e.g., using carrier aggregation (CA), dual connectivity (DC) or multi-connectivity (MC).

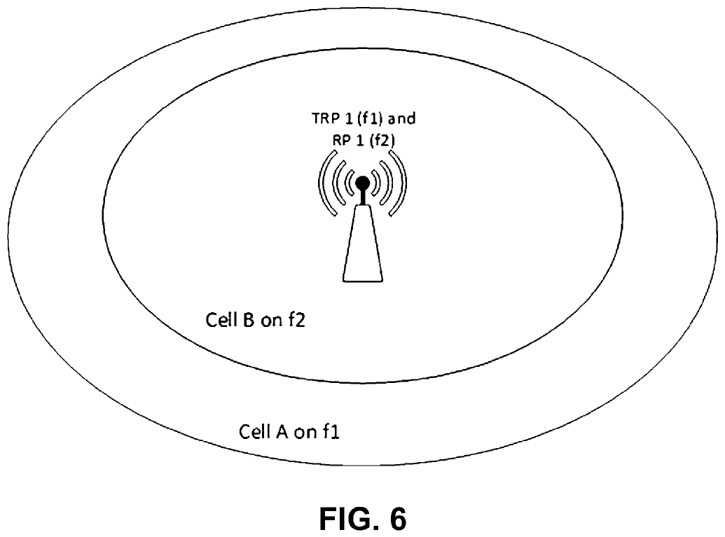

FIG. 6 is an illustration of a site serving two cells (Cell A and Cell B) at two frequency layers (f1 and f2). On Cell A the site provides a TRP and on Cell B the site provides an RP. Cell B may be an UL-only SCell. In a cellular system, a site may serve one or more cell(s) on one or more frequency layer(s). In some cases, the site includes a TRP on each of the frequency layers. However, in some cases, a site may provide a TRP for a first cell on a first frequency layer while providing an RP for a second cell on a second frequency layer. This scenario is illustrated in FIG. 6, in which a site serves cell A on frequency layer f1 and cell B on frequency layer f2. For cell A, the site provides a TRP while on cell B the site provides an RP. A reason the site does not provide transmission on cell B may be that the site lacks such capabilities, e.g., transmission capabilities for frequency layer f2. Another reason may be that the cell B may not include DL transmissions, e.g., it is an UL-only secondary cell (SCell). Note that being an UL-only SCell may be a matter of configuration, for example, the cell may be UL-only during some time period, while being reconfigured to include DL in some other time period. Thus, the site could act as a TRP on cell B during such time periods if it has such capabilities.

In some cases, a cell may be configured with a supplemental uplink (SUL) carrier, in addition to the normal UL carrier. The SUL carrier may be in a different frequency band than both the DL and the normal UL of the cell. On the SUL carrier there may be only RP(s) and no TRP(s).

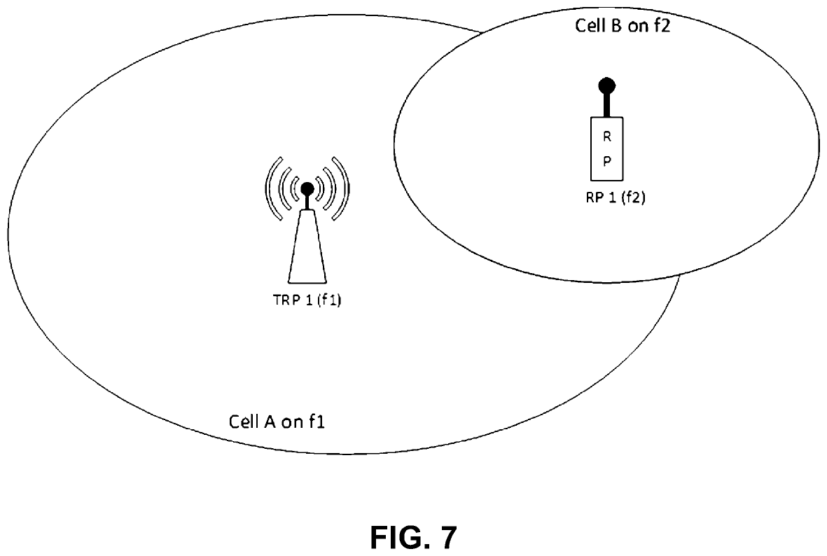

FIG. 7 illustrates TPR1 serving Cell A on frequency layer f1 and RP1 serving Cell B on frequency layer f2. Cell B may be an UL-only SCell. The points serving cells may not be co-located, as illustrated in FIG. 7. The different frequencies, e.g., f1 and f2, may be close to each other in frequency, e.g., in the same frequency band, or not close in frequency, e.g., in different frequency bands. If the frequencies are close enough, beamforming properties may be similar on the different frequencies. If not, beamforming properties may be quite different. For example, consider the scenario in FIG. 6. A good UL beam pair (WTRU Tx beam and TRP/RP Rx beam) on Cell A is likely a good UL beam pair for Cell B, if f1 and f2 are close enough. However, if f1 and f2 are too far apart, this may not be the case. For the scenario depicted in FIG. 7, beams derived for communication on Cell A may not be suitable for communication on Cell B, even if f1 and f2 are close, since the points serving the cells are geographically separated.

There may be reasons why proper control of uplink transmission power may be important in wireless communication systems. For example, a WTRU that is far away from the UL receiver may need to transmit with sufficient power in order to achieve a certain SNR at the receiver. For example, a WTRU that transmits with higher power than required to meet a certain SNR target may create unnecessary interference to other UL receivers, thereby reducing the system performance. For example, a WTRU that transmits with higher power than required to meet a certain SNR target may have unnecessarily high power consumption, thereby reducing its battery life. For example, in simultaneous frequency-division multiplexed (FDMed), UL reception of signals/channels from multiple WTRUs in a carrier, it may be advantageous if the received power spectral densities of the signals/channels from the multiple WTRUs are roughly similar and aligned with the automatic gain control (AGC) setting of the UL receiver. For example, in simultaneous spatial-division multiplexed (SDMed), UL reception of signals/channels from multiple WTRUs (e.g., UL MU-MIMO), it may be advantageous if the received power spectral densities of the signals/channels from the multiple WTRUs are roughly similar, resulting in roughly similar signal to interference plus noise power ratios (SINRs) for the WTRUs.

A WTRU may determine the transmit power for an UL transmission based on various factors, such as its configuration, its capabilities (e.g., maximum transmit power), regulations on maximum permissible exposure (MPE), the estimated pathloss to the receiver, and received transmit power control (TPC) commands. An example power control equation for an UL transmission on an active UL bandwidth part (BWP) of a serving cell on a carrier is shown in Equation 1.

$${P}_{TxUL} = min \{ \begin{matrix}{P}_{CMAX} \\ {P}_{0} + 10 log ( BW ) + {P}_{Δ} + α P {L}_{D L} + {P}_{C L}\end{matrix} [ dB m ] \qquad Equation 1$$

where
P_{TxUL} is the transmit power of the considered UL transmission,
P_{CMAX} is a maximum transmission power,
P₀ is a network-configurable (nominal) target received power,
BW is a bandwidth corresponding to the UL transmission,
P_{Δ} is a power offset term that may depend on various factors, such as the type of the considered UL transmission, modulation and coding scheme (MCS) used for the UL transmission, etc.,
α is a network-configurable coefficient for fractional open-loop power control, typically with 0≤α≤1,
PL_{DL} is an estimated downlink pathloss, and
P_{CL} is a closed-loop power offset.

The open-loop power control (e.g., αPL) and closed-loop power control (e.g., P_{CL}) are further discussed below. A goal of open-loop power control may be to compensate for varying pathloss between the WTRU and the UL receiver. Open loop means that the compensation is independently performed by the WTRU without transmit power control (TPC) commands, i.e., the WTRU-network loop is not closed. To compensate for the pathloss, the WTRU may estimate it. Since it may be difficult for a WTRU to directly estimate the UL pathloss, it instead may estimate the DL pathloss. This may be done by estimating the received power of a DL signal with known transmit power. For example, see Equation 2 below.

$$P {L}_{D L} = {P}_{T x D L} - RSRP [ dB ] \qquad Equation 2$$

where
PL_{DL} is the estimated downlink pathloss.
P_{TxDL} is the known transmit power of the measured DL signal, e.g., total power or power per resource element. The unit may be for example dBm.
RSRP is the estimated received power of the measured DL signal at the WTRU, typically with the same unit as P_{TxDL}.

In some cases, e.g., in time division duplex (TDD) systems, the uplink pathloss may be assumed to be the same as the downlink pathloss. In other cases, e.g., in frequency division duplex (FDD) systems, the uplink pathloss may be different from the downlink pathloss. However, the uplink pathloss and downlink pathloss typically are strongly correlated. For example, a reasonable estimate of the UL pathloss may be PL_{UL}≈βPL_{DL}. If the UL carrier is in a lower carrier frequency than the DL carrier, a β value less than 1 is typically suitable.

In fractional open-loop power control, the WTRU may not fully compensate increased pathloss with increased transmit power. If so, it may compensate only a fraction of the increased pathloss. For example, the WTRU may add transmit power αPL_{DL} as in Equation 1. The value of a is typically configurable by the network. An α value smaller than 1 can be used to better estimate the uplink pathloss, e.g., α≈β. The value of a can also be used for other purposes, such as reducing the uplink transmit power of WTRUs at the cell edge in order to reduce the interference in the system. This means that an α value smaller than 1 may be useful also in TDD systems and an α value smaller than β may be useful in FDD systems. Example values of a may include: 0, 0.4, 0.5, 0.6, 0.7, 0.8, 0.9, 1.

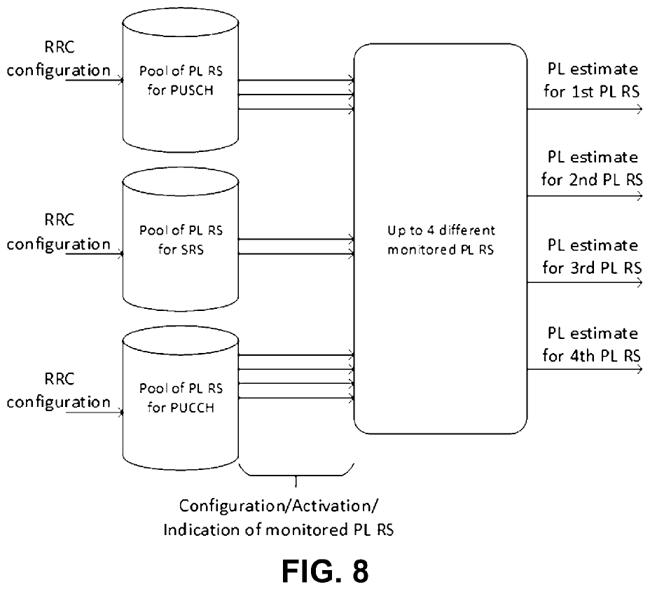

A DL RS on which the WTRU measures RSRP for the purpose of pathloss estimation may be called a pathloss reference signal (PL RS). For example, both SSBs and channel state information-reference signal (CSI-RS) may serve as PL RS. The network may configure the WTRU with one or more pools of PL RS per bandwidth part (BWP) or per serving cell. Continuous reception and measurement of all PL RS in a pool may require an unnecessarily large effort by the WTRU, resulting in significant power consumption. Instead, only a subset of the PL RS in the configured pool may be monitored, i.e., received and measured, herein called the set of monitored PL RS or simply the monitored PL RS. There may be different mechanisms to select the subset, for example an indication by the network through downlink control information (DCI), medium access control-control element (MAC CE), and/or radio resource control (RRC) configuration. For example, a WTRU may be configured with a pool of PL RS for physical uplink shared channel (PUSCH), comprising up to 64 PL RS for a BWP, as well as a pool of PL RS for sounding reference signal (SRS) and a pool of PL RS for physical uplink control channel (PUCCH), each also comprising up to 64 PL RS. However, in an example embodiment, up to 4 of those PL RS may be monitored, e.g., the subset of monitored PL RS may comprise up to 4 PL RS. This maximum number may include the PL RS for the different channels (PUSCH, PUCCH) and signals (SRS), i.e., the union of the subsets selected from each pool may comprise no more than 4 different PL RS. This is illustrated in FIG. 8.

FIG. 8 is an illustration of a configuration of PL RS pools for different channels/signals, configuration/activation/indication of three subsets of monitored PL RS. 3 PL RS are selected from the first pool, 2 PL RS are selected from the second pool, 4 PL RS are selected from the third pool. In an example scenario, the union of those three subsets may not exceed 4 different PL RS. The limit of 4 different PL RS is an example. Any appropriate limiting number of PL RS may be implemented.

A physical random access channel (PRACH) transmission may be associated with a DL RS, e.g., an SSB or a periodic channel state information reference signal (CSI-RS). The associated DL RS may also be used as a PL RS for the PRACH transmission.

In closed-loop power control, the network, e.g., a gNB, may issue transmit power control (TPC) commands to the WTRU using downlink control signaling. Closed-loop power control may be faster than the open-loop power control. While open-loop power control may properly adjust UL transmit power to long-term changes, such as pathloss and shadowing, closed-loop power control may adjust UL transmit power to fast fading. However, such operation relies on frequent uplink transmissions, such as uplink sounding reference signals (SRS), for UL received power measurement, as well as frequent downlink control signaling to carry the TPC (transmit power control) commands. Hence, closed-loop power control may be suitable during (typically short) bursts of heavy uplink data transmission, while incurring too much overhead and power consumption during the (typically long) time periods with lighter uplink data transmission.

There are various implementations of closed-loop power control. In one example, a WTRU may accumulate the offsets received in subsequent transmit power control (TPC) commands. In some cases, only the TPC commands in a certain time window are included in the accumulation. For example, the closed-loop power offset P_{CL} in Equation 1 may be the sum of the offsets indicated in the received TPC commands in the K symbols preceding the considered UL transmission. In some cases, the accumulated sum may be reset upon certain events such as a power control parameter reconfiguration. In another example, the TPC command may carry an absolute power offset, e.g., P_{CL} in Equation 1 equals the offset in the latest applicable TPC command. In other words, past offsets are not accumulated as in the previous example.

Uplink power control may include both open-loop and closed-loop power control. Open-loop power control may rely on the WTRU measuring the received power of a DL RS in order to estimate the pathloss. Example scenarios however, as described herein, may include RPs, which do not transmit DL RS. Therefore, existing open-loop power control mechanisms may not be applicable for controlling the UL transmit power to an RP. Even though closed loop power control may be used towards an RP, it is associated with high overhead, WTRU power consumption, etc. Therefore, it may be beneficial to combine open-loop and closed-loop power control, while using the closed-loop control sparingly, e.g., during bursts of heavy UL data traffic. Hence, it may be beneficial to enhance open-loop power control for UL transmission considering the presence of RPs in wireless network deployments.

Open loop power control may be enhanced. Focusing now on open-loop power control (OL PC) to RPs, state-of-the-art OL PC may not work because the RP does not transmit any DL RS. Consequently, it may not be possible for the WTRU to estimate the pathloss to the RP by measuring the RSRP of a PL RS with known transmit power. Novel OL PC methods are required. Scenarios with one RP are described herein for simplicity, however, embodiments should not be limited thereto. Herein described embodiments are readily applicable to deployment scenarios comprising multiple RPs.

Sets of configured and monitored pathloss reference signals may be utilized. For example, let [symbol] _{type} denote the set of PL RS indices for a pool of configured PL RS of a type of UL transmission, configured for a particular WTRU. The set, for example, may be applicable in a particular BWP (e.g., UL BWP), serving cell, carrier, or band. A type may for instance include one or more of PUSCH, SRS, PUCCH, and/or PRACH. In one example, there may be separately configured [symbol] _{PUSCH}, [symbol] _{SRS}, [symbol] _{PUCCH}. In another example, there may be a pool for multiple (or even all) channels/signals, e.g., [symbol] _{PUSCH,SRS,PUCCH}.

A PL RS may be for example an SSB, a CSI-RS (e.g., a periodic CSI-RS), a tracking RS (TRS), or a positioning RS (PRS). The PL RS indices may be configurable for each PL RS in a pool, which means that the indices might not be consecutive. In another example, the indices in a pool may be consecutive, e.g., 0, 1, 2, . . . , e.g., by the ordinal position in a configured list. In the case of multiple pools, the sets of indices may for example be disjoint, e.g., a certain index may not be included in multiple pools. In another example, the same index value may be included in multiple pools, and in some cases, it may correspond to the same DL RS, while in other cases it may correspond to different DL RS.

Let [symbol] _{type} denote a set of indices for a subset of the monitored PL RS for UL transmissions of a type. The set may for example be applicable in a particular BWP (e.g., UL BWP), serving cell, carrier, or band, for the WTRU. Let [symbol] denote the union of the sets [symbol] _{type} of different types. The union may exclude duplicates of the same DL RS, even if the duplicates correspond to different indices in the different [symbol] _{type}. As discussed above, the size (cardinality) of [symbol] may be constrained, e.g., due to WTRU power consumption. For example, the maximum number of PL RS in [symbol] may be equal to 4, 6, 8, 10, 12, 16, 24, or 32.

In one example, [symbol] _{type}, may be a subset of [symbol] _{type}, e.g., an index in [symbol] _{type} corresponds to the DL RS configured with the same index in [symbol] _{type}. In another example, indexing in [symbol] _{type} may be different from the indexing in [symbol] _{type}. For example, [symbol] _{type} may equal {0, 1, (N_{type}−1}, with index j corresponding to an index in [symbol] _{type} that may be different from j. However, there is an association between an index in [symbol] _{type} and an index in [symbol] _{type}, so that each index in [symbol] _{type} is associated with the corresponding DL RS.

A generalized pathloss calculation may be utilized. In one general method, the WTRU may calculate a pathloss estimate, to be used for power control of an UL transmission i of a type t(i), based on the estimated RSRPs and the transmit powers of the monitored PL RSs, e.g., as in Equation 3.

$$P {L}_{i} = {f}_{t ( i )} ( {RSRP}_{j} , {P}_{TxDL , j} ∀ j ∈ {𝒜}_{t ( i )} ) [ dB ] \qquad Equation 3$$

where
PLᵢ is a pathloss estimate used for OL PC for UL transmission i.
RSRPⱼ is the measured RSRP of the j^{th} PL RS (PL RSRP) in the subset of monitored PL RS, with indices [symbol] ₜ₍ᵢ₎
P_{TxDL,j} is the transmit power of the j^{th} PL RS in the subset of monitored PL RS, with indices [symbol] ₜ₍ᵢ₎. The value of this parameter is typically configured by the network to the WTRU.
fₜ₍ᵢ₎(.) is the function that maps the RSRP measurements and PL RS transmit powers to a PL estimate.

In one example, the OL PC for UL transmission i of type t(i) may be based on PL RS with index p(i), as reflected in Equation 4.

$$\begin{matrix}{PL}_{i} = {f}_{t ( i )} ( {RSRP}_{j} , {P}_{TxDL , j} ∀ j ∈ {𝒜}_{t ( i )} ) = {P}_{TxDL , p ( i )} - {RSRP}_{p ( i )} & [ dB ]\end{matrix} \qquad Equation 4$$

where p(i) is an index in [symbol] ₜ₍ᵢ₎. Note that p(i) may depend on the type of UL transmission i, e.g., if it's a PRACH, PUSCH, SRS, or PUCCH, as well as previous RRC configuration, MAC CE activation, and/or indication by DCI. In one example, a PUSCH transmission (e.g., UL transmission i with t(i)=PUSCH) is scheduled by a DCI that also indicates p(i), e.g., indirectly through an SRS resource indicator (SRI).

In some cases, there may be no pool of configured PL RS for a type. Instead, some PL RS may be directly configured into [symbol] _{type}. For example, a DL RS configured as PL RS in a periodic SRS resource set may be directly included in [symbol] _{SRS} as it is to be monitored without further activation or indication.

Henceforth, for simplicity, the notation A will be used to represent a set of indices of monitored PL RS. In some cases, it may correspond to monitored PL RS for the UL transmission type, e.g., [symbol] _{type}. In some cases, it may correspond to monitored PL RS for all UL transmission types, e.g., [symbol] .

Furthermore, for simplicity, the notation f(.) is used for the pathloss computation formula, even though it may be applicable/specific to certain UL transmission types or even to all types. The UL transmission index i may also be omitted for simplicity of presentation.

In an example embodiment, a reception point (RP) may measure downlink reference signals (DL RSs), such as, for example RSRP. In a TDD system, RPs may have such a capability since DL transmission and UL reception may be performed with the same carrier frequency. Since the RPs lack transmission capability, they may continue to receive during DL symbols, at least occasionally, in order to perform measurements on DL RS, e.g., PL RS.

In an FDD system, however, RPs may not be able to continuously perform measurements on the DL, since they may need to receive UL channels/signals on the UL carrier. However, an RP may switch its receiver to the DL carrier to perform measurements during periods it doesn't have to perform UL reception. Since the scheduling of UL transmissions is typically controlled by the network, measurement gaps may occur. Furthermore, an RP may be capable of multi-carrier reception, just like a typical WTRU. If so, an RP may simultaneously receive UL channels/signals on an UL carrier and DL RS on a DL carrier.

In example scenarios, both TRPs and RPs may be static (stationary), e.g., they do not move. In such scenarios, infrequent measurement of DL RS by the RP may be sufficient, since the RSRP may not change much with time.

Accordingly, RSRP measurements on DL RS by the RP, e.g., on the PL RS in the set of monitored PL RS [symbol] for a WTRU may be available to the network. Different WTRUs may have different sets [symbol] configured/activated/indicated and an RP may perform measurements on all of these sets. However, it may be likely that different WTRUs near an RP monitor the same, or almost the same, set of PL RS.

Let RSRP_{RP,j} denote the measured received power at the RP, of PL RS j in a subset of monitored PL RS [symbol] for a WTRU. Since RSRP_{RP,j} is measured at the network side (at the RP), it is not immediately available at the WTRU. Therefore, in an example embodiment, RSRP_{RP,j} (at least for the j in [symbol] ) may be signalled to the WTRU, e.g., using RRC configuration, MAC CE, and/or DCI. A set of RSRP values, each corresponding to a PL RS, can be seen as an RP RSRP signature.

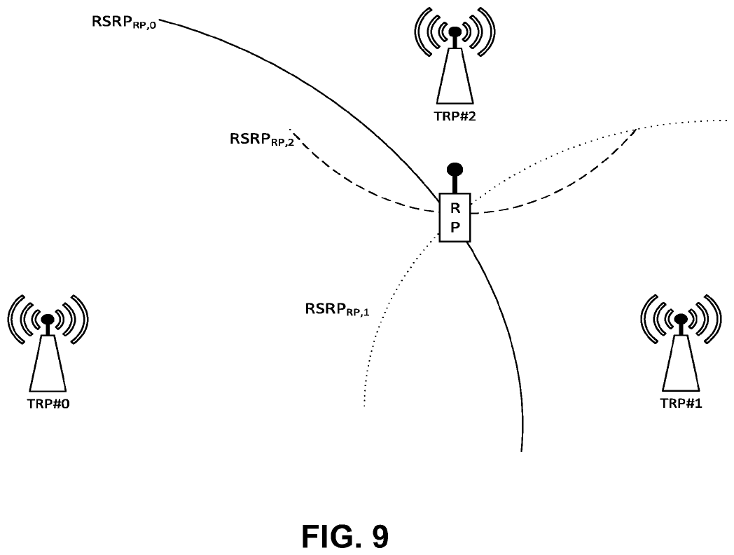

FIG. 9 is an example illustration of RP RSRP signatures. FIG. 9 depicts three different TRPs, wherein each TRP transmits a PL RS. TRP #0 transmits a PL RS with index j=0, TRP #1 transmits a PL RS with index j=1, and TRP #2 transmits a PL RS with index j=2. The RP measures the RSRP of the three DL RS. The RP RSRP signature, e.g., as configured to a WTRU, would be the corresponding RSRP values RSRP_{RP,j} for j=0, 1, 2. The curves for RSRP_{RP,j} may represent the locations with that particular RSRP value. Such curves as in this example may occur for instance in frequency range (FR1) with wide (e.g., sectorized) or omni-directional transmission beams.

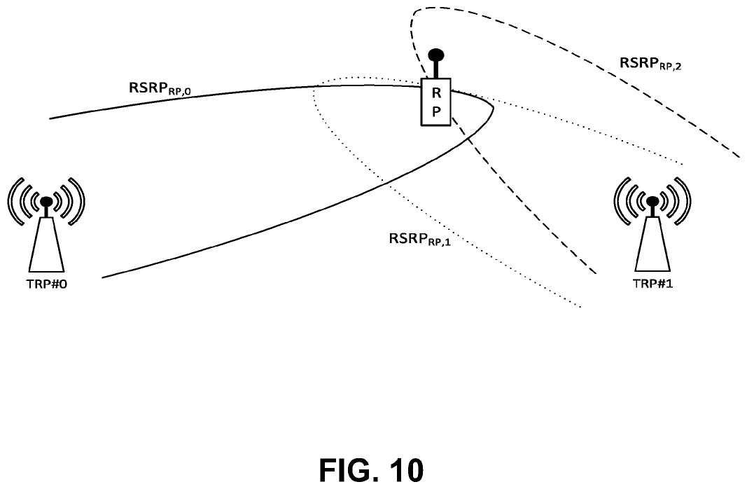

FIG. 10 is an example illustration of RP RSRP signature with directional beams. The curves illustrate the locations with the corresponding RSRP values. While FIG. 9 illustrates an example scenario with wide or omni beams transmitted by the TRPs, FIG. 10 illustrates an example with directional beams, e.g., using beamforming in FR2. As depicted in FIG. 10, one beamformed PL RS from TRP #0 and two beamformed PL RS from TRP #1 are shown. While this example shows a single intersection between the three RSRP lines, it is possible that they cross in multiple locations. This may result in location ambiguity and inaccurate OL PC. To avoid such ambiguities, it may be beneficial to include as many PL RS as possible and PL RS transmitted by as many TRPs as possible in an RP RSRP signature.

In some cases, e.g., FR1, it may be assumed that the RSRP measurement result of a WTRU co-located with an RP is similar to the corresponding RSRP measurement result of the RP. In some cases, e.g., frequency range 2 (FR2), however, the RSRP measurement result of the WTRU and the RP may differ, even if they are co-located. For example, the WTRU and the RP may be equipped with a different number of receive antennas, which may result in different RSRP after receiver beamforming. Furthermore, even if the WTRU and RP are equipped with similar receiver antenna systems, the RSRP may vary due to different used receiver beams at the WTRU and the RP. This scenario may be addressed by various methods.

For example, the network may, in advance, estimate a typical power offset between a WTRU RSRP measurement result and a co-located RP RSRP measurement result. Then, the RP RSRP value that the network configures to the WTRU may be the actual RSRP measurement result at the RP but adjusted with this estimated power offset. The network may take into account the WTRU class/category and WTRU capabilities in the estimation of the power offset. For example, the network may estimate and apply a larger power offset to a WTRU with reduced capabilities, e.g., fewer receive antennas, compared to a highly capable WTRU with more receive antennas. Typical power offset(s) between RP-measured RSRP and WTRU-measured RSRP may be estimated in advance, e.g., by the RP manufacturer, for instance by extracting WTRU-measured RSRP values for various WTRU classes etc. Any power offset that remains after compensation may impact the accuracy of pathloss estimation to the RP, e.g., according to methods discussed below, and therefore open loop based transmit power. Such may be systematic and may be subsequently handled by closed loop adjustments.

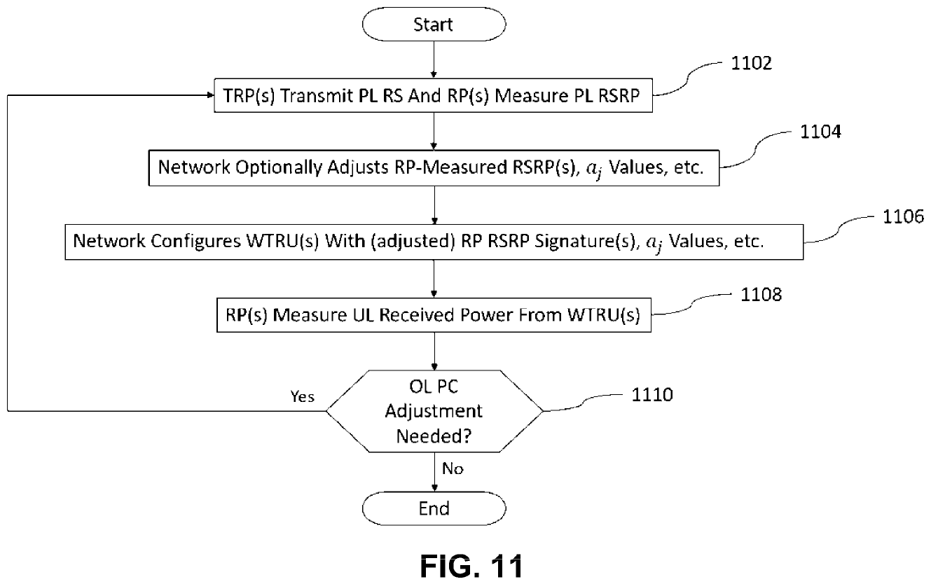

The discussion below assumes that the WTRU-measured RSRP is similar to the corresponding RP-measured RSRP, for a particular PL RS. FIG. 11 is an example flow diagram of an example procedure for performing open loop power control. At step 1102, the TRP(s) may transmit PL RS and the RP(s) measure the corresponding RSRP. At step 1104, the network optionally adjusts the RP-measured RSRP values, e.g., as discussed above, into values that are to be included in a WTRU configuration. Other parameters, such as the weight factors αⱼ (introduced below), may be adjusted. Input to the adjustment at step 1104 also may be UL received power measurements at the RP(s). For example, if the UL received power at the RP(s) is systematic too low/high, this may be addressed by adjusting the values in the OL PC configuration(s). At step 1106, the network may send a downlink signal, wherein the downlink signal is configured to configure WTRUs with the adjusted values, such as the RP RSRP signature(s), weight factors αⱼ, etc. At step 1108, the RP(s) receive UL uplink transmissions from WTRU(s), for which the WTRUs have used to configured OL PC for transmission to an RP (e.g., the transmission power of the uplink signal is based on the value RSRP, adjusted or not adjusted). The RP(s) measure that UL received power at step 1108. At step 1110, the network may determine if an adjustment of the OL PC-related configuration values is needed, e.g., if the difference between SINR of the received signal at the RP(s) and target SINR exceeds a threshold (or the received power at the RP(s) deviates too much from the target received power). If so, it may initiate the power control parameter adjustment in step 1102. Note that performing an adjustment in step 1102 does not imply that all WTRUs need to be reconfigured with new values. In some cases, the newly adjusted values are given only to WTRUs without a previous OL PC configuration for transmission to the RP(s). In some cases, e.g., if the new adjustments are significant, also the WTRUs with previous OL PC configuration for transmission to RP(s) are reconfigured. Furthermore, step 5 may be omitted, e.g., in a network implementation that continuously adjusts RP RSRP signature(s), weight factors, etc., based on UL received power measurements.

With the goal of enhancing OL PC to better support UL transmissions to RPs, novel forms of the pathloss computation f(.) formula are described. In an example scenario, OL PC behavior would result in minimum transmit power if the WTRU position is just next to the RP (i.e., WTRU co-located with RP), with transmit power increasing with increased distance between the WTRU and the RP. In other words, the pathloss formula (f(.)) may have it's minimum when the WTRU-measured RSRP is equal to an RP RSRP signature. For example, the WTRU may compute the pathloss as in Equation 5.

$$\begin{matrix}\overline{PL} = {\sum }_{j ∈ 𝒞} {a}_{j} Δ {RSRP}_{j} & [ dB ]\end{matrix} \qquad Equation 5$$

where
P̅L is an enhanced pathloss estimate.
ΔRSRPⱼ=|RSRPⱼ−RSRP_{RP,j}| is the absolute value of the difference between the WTRU-measured RSRP and RP-measured RSRP of PL RS j.
[symbol] is a set of indices corresponding to the PL RS included in the RP RSRP signature, i.e., the WTRU has been configured with the values RSRP_{RP,j} for j∈ [symbol] .
   [symbol] may be a subset of or equal to [symbol] .
   The determination of the set [symbol] is further discussed herein.
αⱼ is weight factor for the PL RS j. They can be used to further adjust the pathloss computation.

Equation 5 indicates that the estimated enhanced PL is zero [dB] when the WTRU measured RSRP equals the RP RSRP signature, i.e., RSRPⱼ=RSRP_{RP,j}. The weight factors αⱼ may for instance be given by a specification. In one example, αⱼ=1. In another example, αⱼ=α, e.g., α=1/| [symbol] |, where | [symbol] |≥1 is the size of the set C. The weight factors αⱼ or a weight factor α may for instance be configured by the network. Suitable values may for example be based on the relative positions of the TRPs and RP.

In another example, the WTRU may compute the enhanced pathloss as in Equation 6,

$$\begin{matrix}\overline{PL} = {median}_{j ∈ 𝒞} ( Δ {RSRP}_{j} ) & [ dB ]\end{matrix} \qquad Equation 6$$

where median(.) takes the median value. In some cases, multiplication with a weight factor αⱼ is included inside the median operator or multiplication with a weight factor α is included outside the median operator. Note that the enhanced pathloss formulas, e.g., in Equation 5 or Equation 6, may be approximations of the actual WTRU to RP pathloss. With a suitable choice of weight factors αⱼ, a better approximation can be obtained. The suitable choice of weight factors may depend on several aspects, such as the network geometry/topology (e.g., relative positions and distances between TRPs/RPs), which kind of beamforming that is applied to the PL RSs, etc. However, if those aspects are static or changing slowly, it may be possible to improve the PL approximation accuracy, e.g., by gradually adjusting the weight factors αⱼ and or the configured RSRP_{RP,j} values.

It may be beneficial to fit the enhanced PL computation discussed herein into the legacy PL computation formula in Equation 2, e.g., in order to reduce specification impact. To this end, virtual pathloss RS may be defined. For example, a transmit power of a virtual PL RS may be the sum of the transmit powers of the monitored PL RS in [symbol] , e.g., as defined as in Equation 7.

$$\begin{matrix}{\overline{P}}_{TxDL} = {\sum }_{j ∈ 𝒞} {P}_{TxDL , j} & [ dB ]\end{matrix} \qquad Equation 7$$

The power summation may be carried out in dB scale (e.g., in dBm) or in linear scale (e.g., in W). In fact, this virtual PL RS transmit power will be cancelled out in a later computation. Still, in order to make sense, the power addition result may be performed in the linear domain and then returned to the dBm domain.

An RSRP of a virtual PL RS (virtual PL RSRP) may be defined as in Equation 8.

$$\overline{RSRP} = {\overline{P}}_{TxDL} - \overline{PL} \qquad Equation 8$$

Here, P̅L̅ is an enhanced PL estimate, for example as in Equation 5 or Equation 6.

For example, the virtual PL RSRP based on the enhanced PL estimate in Equation 5 gives the following.

$$\begin{matrix}\overline{RSRP} = {\overline{P}}_{TxDL} - {\sum }_{j ∈ 𝒞} {a}_{j} Δ {RSRP}_{j} & [ dB ]\end{matrix} \qquad Equation 9$$

Similarly, for the alternative PL computation based on median, the virtual PL RSRP based on the enhanced PL estimate in Equation 6 gives the following.

$$\begin{matrix}\overline{RSRP} = {\overline{P}}_{TxDL} - {median}_{j ∈ 𝒞} ( Δ {RSRP}_{j} ) & [ dB ]\end{matrix} \qquad Equation 10$$

Now, inserting the transmit power and RSRP of a virtual PL RS of Equation 9 into Equation 2 gives the following.

$$\begin{matrix}{PL}_{DL} = {\overline{P}}_{TxDL} - \overline{RSRP} = {\overline{P}}_{TxDL} - ( {\overline{P}}_{TxDL} - {\sum }_{j ∈ 𝒞} {a}_{j} Δ {RSRP}_{j} ) = {\sum }_{j ∈ 𝒞} {a}_{j} Δ {RSRP}_{j} & [ dB ]\end{matrix} \qquad Equation 11$$

In other words, the legacy pathloss computation (Equation 2) using virtual PL RS transmit power and virtual PL RSRP gives the enhanced PL estimate. Similarly, inserting the virtual PL RS of Equation 10 into Equation 2 gives the corresponding enhanced (median-based) PL estimate. It can be noted that the exact definition of P̅_{TxDL} has no impact on Equation 11 since the term is cancelled. Hence, various other definitions of P̅_{TxDL} may be considered within this framework.

Another example of OL PC based on virtual pathloss RS is given below. For example, a transmit power of a virtual PL RS may be the sum of the transmit powers of the monitored PL RS in [symbol] , e.g., as defined as in Equation 12.

$$\begin{matrix}{\overline{P}}_{TxDL} = {\sum }_{j ∈ 𝒞} {a}_{j} {P}_{TxDL , j} & [ dB m ]\end{matrix} \qquad Equation 12$$

The power summation may be carried out in dB scale (e.g., in dBm) or in linear scale (e.g., in W), and αⱼ are weight factors, e.g., as discussed above. An RSRP of a virtual PL RS may be defined as in Equation 8. Furthermore, the virtual PL RSRP based on the enhanced PL estimate in Equation 5 gives the following.

$$\begin{matrix}\overline{RSRP} = {\sum }_{j ∈ 𝒞} {a}_{j} {P}_{TxDL , j} - {a}_{j} Δ {RSRP}_{j} = {\sum }_{j ∈ 𝒞} {a}_{j} ( {P}_{TxDL , j} - Δ {RSRP}_{j} ) & [ dB ]\end{matrix} \qquad Equation 13$$

Now, inserting the transmit power and RSRP of a virtual PL RS of Equation 13 into Equation 2 gives the following.

$$\begin{matrix}{PL}_{DL} = {\overline{P}}_{TxDL} - \overline{RSRP} = {\overline{P}}_{TxDL} - ( {\overline{P}}_{TxDL} - {\sum }_{j ∈ 𝒞} {a}_{j} Δ {RSRP}_{j} ) = {\sum }_{j ∈ 𝒞} {a}_{j} Δ {RSRP}_{j} & [ dB ]\end{matrix} \qquad Equation 14$$

Again, the legacy pathloss computation (Equation 2) using virtual PL RS transmit power and virtual PL RSRP gives the enhanced PL estimate.

For the solutions based on RP estimation of RP RSRP signatures, e.g., as described herein, further details are discussed below. For example, a WTRU may be configured with one or more pools of PL RS. The configuration of a PL RS (e.g., as PUSCH-PathlossReferenceRS, PUCCH-PathlossReferenceRS, or PathlossReferenceRS) may comprise a PL RS index (or equivalently ID), a DS RS index (or equivalently ID), for instance an SSB index or a CSI-RS index, or an appropriate combination thereof.

As also discussed above, the PL RS indices of different pools may overlap or be disjoint. In some cases, a joint pool of PL RSs for multiple UL transmission types. In this case, there is a (joint) set of corresponding PL RS indices, that naturally don't overlap between different PL RSs.

In this exemplary solution, a pool or list of virtual PL RSs may be configured. In one example, the list may be configured per UL transmission type, e.g., separately for PUSCH, SRS, and/or PUCCH. In another example, the list may be configured for multiple UL transmission types, e.g., a list for PUSCH and SRS, or a list for PUSCH, SRS, and PUCCH. Like PL RS lists/pools, a virtual PL RS list may be configured per BWP or serving cell. A virtual PL RS list may comprise one or more virtual PL RS configurations (e.g., information elements). A virtual PL RS configuration may, for example, include one or more of the following parameters: a virtual PL RS index, a list of RP signature configurations, or any appropriate combination thereof.

An RP signature configuration (information element) may include one or more of the following parameters: a PL RS index, an RSRP value, e.g., corresponding to RSRP_{RP,j}, a weight factor, e.g., corresponding to αⱼ, or any appropriate combination thereof.

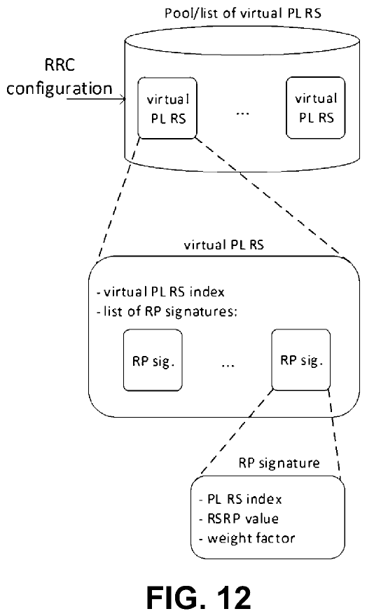

A virtual PL RS may be based on the PL RSs included in the list of RP signature configurations. An exemplary illustration of such a configuration framework is shown in FIG. 12. In this exemplary solution, a pool or list of PL RSs may be enhanced to (e.g., optionally) include a list of virtual PL RS, e.g., in addition to a PL RS index and a DL RS index. A virtual PL RS list may comprise one or more virtual PL RS configurations (e.g., information elements). A virtual PL RS configuration may, for example, include one or more of the following parameters: a virtual PL RS index, an RSRP value, e.g., corresponding to RSRP_{RP,j}, a weight factor, e.g., corresponding to αⱼ, or any appropriate combination thereof.

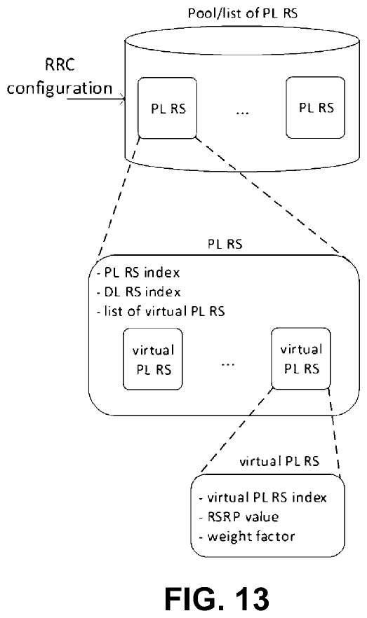

A virtual PL RS may be based on the PL RSs in which the virtual PL RS (index) is included. An exemplary illustration of such a configuration framework is shown in FIG. 13.

In state-of-the-art power control, a certain UL transmission may be associated with a certain PL RS, that is used for the OL PC. With the introduction of virtual PL RS, it may be desirable to also support the association between a certain UL transmission and a certain virtual PL RS.

In dynamic point/beam selection in state-of-the-art systems, subsequent UL transmissions can be directed towards different TRPs/beams, with the subsequent UL transmission consequently using different PL RS for the OL PC. It would be desirable to support dynamic point selection between TRPs and RPs, i.e., dynamic switching the target of subsequent UL transmissions from TRP to RP (or vice versa), or from RP to RP.

To this end, the configuration, activation, and indication of PL RS for UL channels/signals should be enhanced to include virtual PL RS, in addition to PL RS. One exemplary solution is to include the virtual PL RS indices into the index space previously used for PL RS. The network can make sure that no virtual PL RS (e.g., in a BWP or serving cell) is configured with an index equal to a configured PL RS index (e.g., in the same BWP or serving cell).

If the index space previously used for PL RS only is not sufficiently large to also include virtual PL RS indices, the size of the index space can be increased, i.e., the maximum number of (virtual or not virtual) PL RS indices can be increased.

With this exemplary solution, the existing mechanisms to configure a PL RS for an UL signal/channel, e.g., a periodic SRS resource set, may directly be used to configure a virtual PL RS instead, by simply configuring an index that corresponds to a virtual PL RS.

Similarly, existing mechanisms to activate a PL RS for an UL signal/channel, e.g., by a MAC CE, may be readily used to activate a virtual PL RS instead, by including an index that corresponds to a virtual PL RS.

Other exemplary mechanisms to dynamically indicate a PL RS for an UL signal/channel or a particular UL transmission may indicate a virtual PL RS instead of a PL RS, given that the existing signaling relies on PL RS indices.

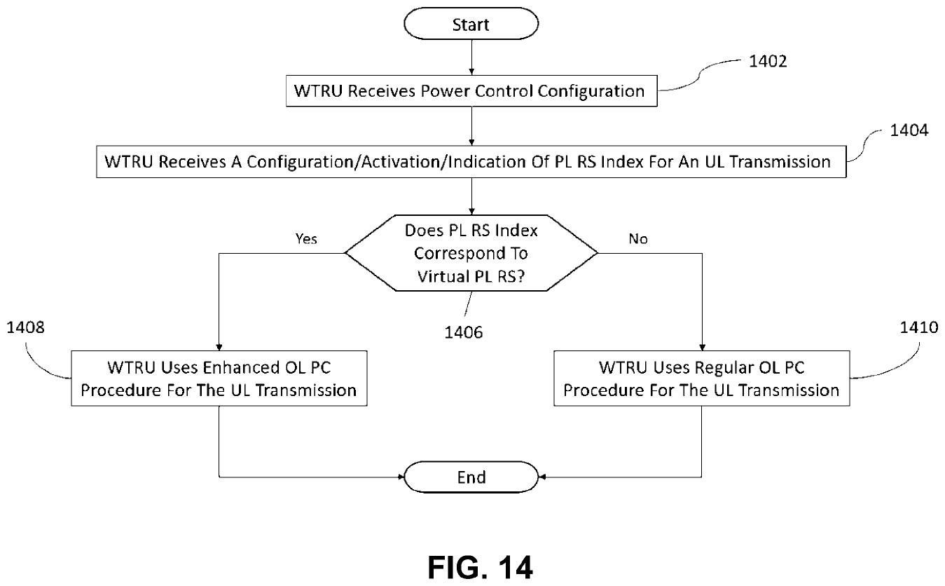

FIG. 14 is a flow diagram of an example process for performing open loop power control. In the first step (step 1), the WTRU may receive a configuration of power control, e.g., including configuration of PL RSs, virtual PL RSs, and RP RSRP signatures. In step 2, the WTRU may receive a configuration, activation (e.g., by MAC CE), and/or indication (e.g., by DCI), of a PL RS index for an UL transmission. This means that the PL RS (virtual or not virtual) corresponding to the index may be used for OL PC for the UL transmission. In step 3, the WTRU may determine if the PL RS index in the previous step corresponds to a regular (e.g., not virtual) PL RS or to a virtual PL RS. The PL RS index may correspond to a virtual PL RS, e.g., if it is equal to a configured virtual PL RS index. Otherwise, the PL RS index may correspond to a configured index of a regular PL RS. In step 4, if the PL RS index in step 2 corresponds to a configured index of a virtual PL RS, e.g., a virtual PL RS index, the WTRU may use an enhanced OL PC procedure, e.g., as described herein. In step 5, if the PL RS index in step 2 corresponds to a configured PL RS index, the WTRU may use a regular OL PC procedure. It may be good to clarify that the PL RS index in step 2 may be a PL RS index configured/activated/indicated for an UL signal/channel (e.g., PUSCH, SRS, PUCCH) or an UL transmission (e.g., a particular scheduled PUSCH or a particular aperiodic SRS transmission). This may be called a PL RS index for an UL transmission. The comparison in step 3, though, may be with a PL RS index or virtual PL RS index in a power control configuration, e.g., a configuration of a pool/list of PL RSs and/or a pool/list of virtual PL RSs.

The WTRU determination of the set C is further discussed here. The set [symbol] may include the PL RS indices that are included in an enhanced PL computation (e.g., for a particular virtual PL RS), e.g., as in Equation 5 or Equation 6. The PL RSs with indices in set C may also be included in a virtual PL RS transmit power computation, e.g., as in Equation 7 or Equation 12.

It may be beneficial if the PL RSs with their indices included in C are currently monitored by the WTRU, which means that the WTRU may perform corresponding PL RSRP measurements. In other words, C may be a subset of, or equal to, the set [symbol] .

A set [symbol] may be applicable to a certain virtual PL RS. In other words, different virtual PL RSs may have different sets C. Hence, the determination of C may be described below for a particular virtual PL RS. In a first approach, if a PL RS index for an UL transmission corresponds to a virtual PL RS index, then the WTRU may expect that the set [symbol] includes only indices of PL RSs that are monitored. In other words, the network may make sure that no RP RSRP signature that is to be used for PC includes a PL RS that is not monitored. In practice, this may imply that the network may configure multiple virtual PL RS for an RP, each based on a different set of PL RS. Depending on which PL RSs that are currently monitored, the network may configure/activate/indicate the corresponding PL RS index for an UL transmission that corresponds to the virtual PL RS that is based on the currently monitored PL RS.

Consider the example in FIG. 8, which has three TRPs and an RP. The network may configure several virtual PL RSs, e.g.:
a first virtual PL RS: the set C includes indices of PL RS 0, 1, and 2.
a second virtual PL RS: the set C includes indices of PL RS 0 and 1.
a third virtual PL RS: the set C includes indices of PL RS 0 and 2.
a fourth virtual PL RS: the set [symbol] includes indices of PL RS 1 and 2.

When the WTRU monitors PL RS 0, 1, and 2, the network may configure/activate/indicate any virtual PL RS for an UL transmission, e.g., the first virtual PL RS. At some other time, the WTRU may only monitor PL RS 0 and 2. In this case, the network may configure/activate/indicate the third virtual PL RS for an UL transmission.

In the first approach described above, the WTRU may follow the configuration/activation/indication. However, with many configured PL RSs and multiple RPs, the number of combinations grows and therefore the RRC configuration overhead. A second approach with less configuration overhead is considered. In a second approach, the network may configure/activate/indicate a PL RS index for an UL transmission that corresponds to a virtual PL RS that is based on one or more currently monitored PL RS and one or more not currently monitored PL RS. In this case, the WTRU includes the one or more currently monitored PL RS in the set [symbol] . In this approach, the network may configure RP RSRP signatures for a large number, or even all, PL RSs. Then, for a certain [symbol] , e.g., set of monitored PL RSs, the WTRU can determine the set C for a virtual PL RS, e.g., as the PL RSs in [symbol] that are included in RP RSRP signatures for the virtual PL RS, as the PL RSs in [symbol] that include the virtual PL RS (index).

In the second approach, it may be sufficient to configure a single virtual PL RS per RP, since it may be based on many PL RSs. Consider the example in FIG. 8 again. The network may configure a single virtual PL RS: a first virtual PL RS: the set C includes indices of PL RS 0, 1, and 2.

The network may configure/activate/indicate the first virtual PL RS for an UL transmission. When the WTRU monitors PL RS 0, 1, and 2, the WTRU may include all three in the set [symbol] . At some other time, when the WTRU monitors only PL RS 0 and 2, for example, the WTRU may include only PL RS 0 and 2 in the set [symbol] .

In some cases, e.g., in the first approach or in the second approach, a WTRU may include a monitored PL RS in the set [symbol] only if its WTRU-measured RSRP is above a certain threshold, e.g., a configurable threshold.

In some cases, e.g., in the first approach or in the second approach, a WTRU may include a monitored PL RS in the set [symbol] only if its WTRU-measured RSRP is below a certain threshold, e.g., a configurable threshold.

Configured PL RSs may be included in the set [symbol] , for example if they have been configured/activated/indicated for an UL transmission. In various examples herein, a virtual PL RS may be configured/activated/indicated for an UL transmission. The virtual PL RS may in turn be associated with (based on) one or more PL RSs, e.g., by configuration as discussed herein. In some cases, the one or more PL RSs on which the virtual PL RS is based may be included in the set A. If not all of these PL RSs may be included in A, for example due to the limited size of A, then a subset of the one or more PL RSs may be included in A, for example the PL RSs with lowest configured PL RS index, or the PL RSs with lowest periodicity.

If legacy UL power control is used in a network with one or more RPs, when the WTRU is close to an RP, the WTRU transmit power may be much higher than necessary or tolerable. One way to address this is to use enhanced power control, e.g., one or more of enhanced OL PC, enhanced CL PC, and/or a certain PC configuration, only in the vicinity of an RP.

A WTRU may be considered to be co-located with an RP if the WTRU-measured RSRPs match the RP-measured RSRPs, e.g., the RP RSRP signature e.g., the difference is zero). Similarly, a WTRU may be considered to be in the vicinity of an RP if the difference between the WTRU-measured RSRPs and the RP RSRP signature is small. In other words, if ΔRSRPⱼ≤V, ∀j∈ [symbol] , the WTRU may be in the vicinity of the RP, where Vis a threshold, that may be fixed or configurable by the network. Equivalently, the WTRU may be in the vicinity of the RP if max_{j∈} [symbol] (ΔRSRPⱼ)≤V.

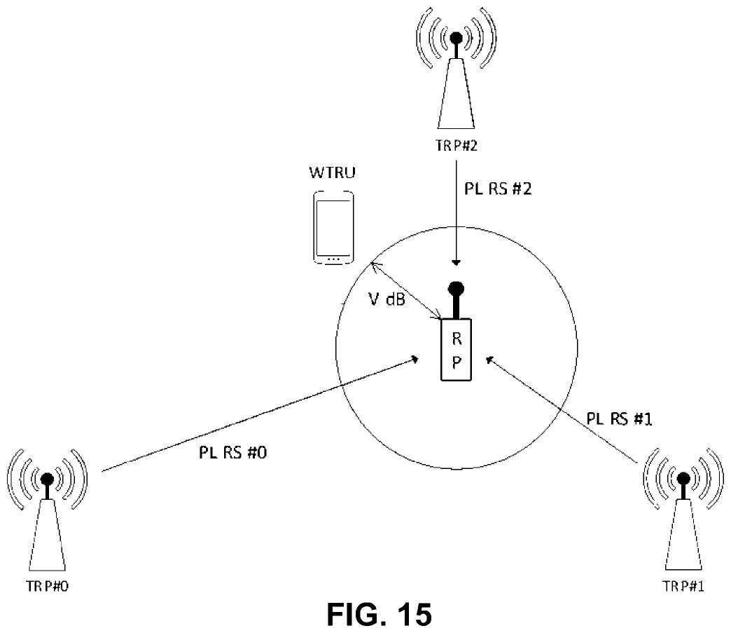

The concept of a vicinity threshold is depicted in FIG. 15. In this example, there are three TRPs which transmit a PL RS each that are included in [symbol] , with PL RS indices j equal to the TRP index, for simplicity. For the WTRU in the exemplary illustration of FIG. 15, ΔRSRP₀≤V and ΔRSRP₂≤V, but ΔRSRP₁>V. Hence, the WTRU may be determined to be outside the RPs vicinity. Note that the two-dimensional circular vicinity is just for illustration. In reality, a vicinity area (or space) may be 3-dimensional and with a non-circular (or non-spherical) shape. A vicinity area/space boundary might not represent a certain physical distance between the RP and the WTRU. Instead, a vicinity area/space boundary may approximate a similarity or proximity in terms of received powers of PL RSs.

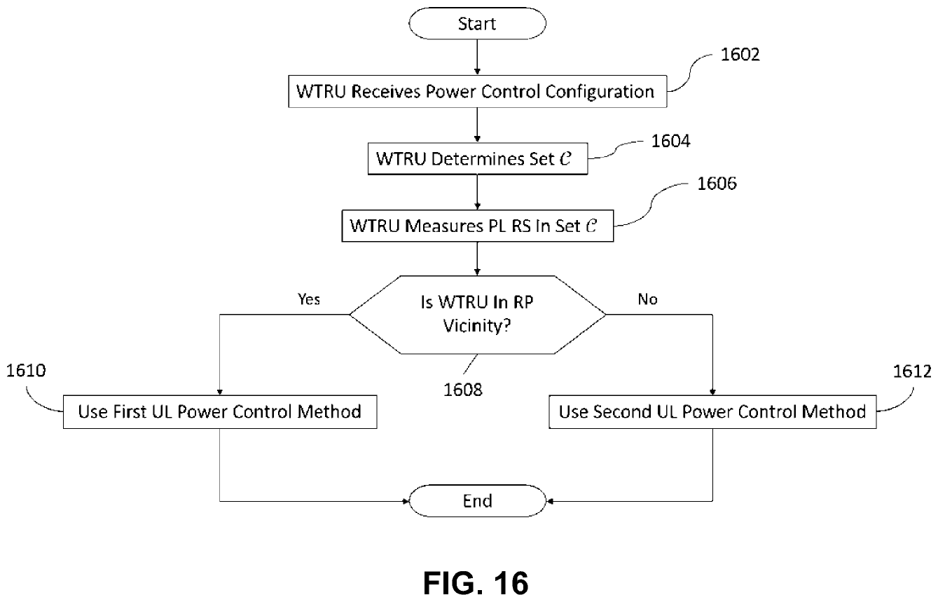

A vicinity area may be used to adjust UL power control. An exemplary procedure is shown in FIG. 16. FIG. 16 is an example process of a WTRU accomplishing power control based on vicinity to a RP or TRP. At step 1602, the WTRU may receive a power control configuration, e.g., with RRC signaling. The configuration may include configuration of an RP RSRP signature, a value of threshold V, a configuration of a first power control method, a configuration of a second power control method, configuration of PL RS, etc., or any appropriate combination thereof. A configuration of a power control method may include for example a target received power P₀, fractional power control coefficient α, etc.

At step 1604, a set [symbol] of PL RS, which are included in an RP RSRP signature, may be determined. This, for example, may be based on a previous configuration, the set of monitored PL RS, etc. At step 1606, the WTRU may measure PL RS in the set [symbol] resulting in WTRU-measured RSRPs for the PL RS in [symbol] . At step 1608, the WTRU may determine if the WTRU is in the RP vicinity, for example, based on a threshold-based criterion discussed above. If the WTRU determines that the WTRU is in the RP vicinity, at step 1610, the WTRU may use a first method for UL power control. If the WTRU determines that the WTRU is not in the RP vicinity, at step 1612, the WTRU may use a second method for UL power control. Examples of first and second methods are further discussed below.

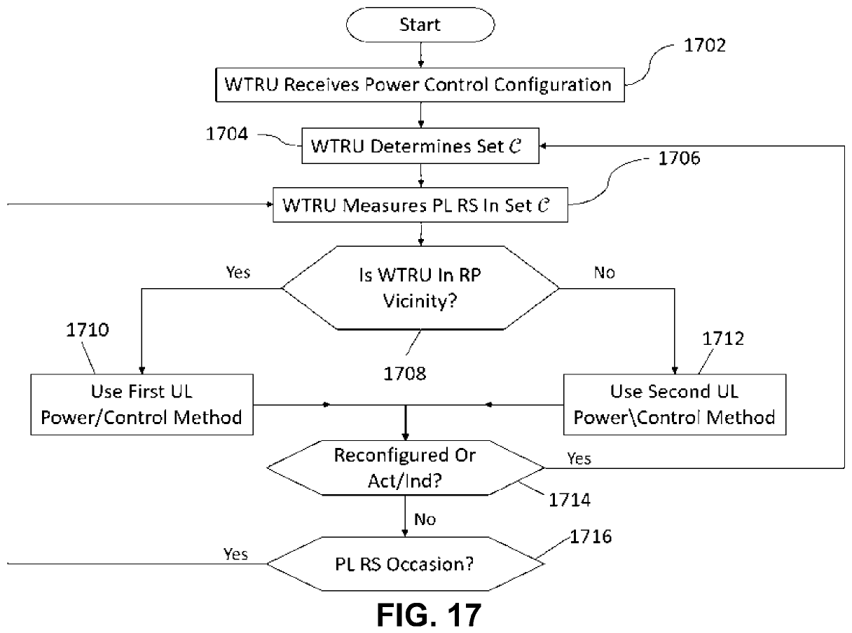

The WTRU procedure might not end after a single iteration but may continue as the WTRU receives control signalling and as PL RS transmission occasions come, as depicted in FIG. 17. FIG. 17 is another example process of a WTRU accomplishing power control based WTRU vicinity. Step 1702 through 1712 of FIG. 17 are similar to steps 1602 through 1612 of FIG. 16. At step 1714, based on subsequent reconfiguration or PL RS activation/indication, the WTRU may return to step 1702. At step 1716, based on subsequent PL RS transmission occasions, the process may return to step 1706. Subsequent WTRU-measured PL RSRP may have the WTRU change the answer in step 1708, resulting in the switching of UL power control method.

Regarding the first UL power control method depicted in step 1610 of FIG. 16 and step 1710 FIG. 17 and the second UL power control method depicted in step 1612 of FIG. 16 and step 1712 of FIG. 17, the first power control method may comprise a first set of power control configuration parameters and the second power control method may comprise a second set of power control configuration parameters. For example, the first set of power control configuration parameters may include a first value of P₀ and a first value of a, e.g., a larger value such as α=1, that results in aggressive pathloss compensation. The second set of power control configuration parameters may include a second value of P₀ and a second value of a, e.g., a smaller value such as α=0. In this example, the WTRU transmit power may depend on the estimated pathloss outside the vicinity area. Within the vicinity area, the WTRU may use a fixed transmit power (independent of estimated pathloss) determined by the second value of P₀ and other parameters. Such a scheme may be useful for instance if the estimated pathloss is inaccurate and a certain (low) transmit power may be suitable anywhere near the RP. If the vicinity area is greater than the inaccuracy area, it is likely that the WTRU will use the second power control method when the WTRU is next to the RP.

In another example, a first power control method comprises using a first power control formula, e.g., as in Equation 1. A second power control method comprises using a second power control formula, e.g., as in Equation 15.

An alternative approach to vicinity estimate may be based on positioning, which is further discussed herein. In this case, the WTRU may determine that the WTRU is in the vicinity of an RP if the estimated distance to the RP (d) is less than or equal to a threshold D that may be configurable, i.e., d≤D. For this approach, steps 2 and 3 in FIG. 16 and FIG>17 may be replaced by the measurement and computation of d.

Another alternative to the enhanced open-loop power control based on RP RSRP signatures and virtual PL PS may be an enhanced interference-aware open loop power control mechanism. In some cases, it may not be possible for the RPs to measure DL RSs, e.g., RSRP, or that the RSRP signatures from the RPs may not be available at the network. Whilst it may be possible to leverage closed-loop power control to dynamically adjust the uplink power to account for interference to RP(s), this may lead to large overhead particularly for dense UL deployments.

In these cases, it may be beneficial to have a mechanism where the WTRU can determine dynamically if possible interference imposed on RP(s) based on the UL transmit power exceeds certain thresholds. In one example, an enhanced interference-aware power control equation for an UL transmission on an active UL BWP of a serving cell on a carder as in Equation 15 may be considered.

$$\begin{matrix}{P}_{TxUL} = min \{ \begin{matrix}{P}_{CMAX} \\ {P}_{c} = {P}_{0} + 10 log ( BW ) + {P}_{Δ} + α {PL}_{DL} + {P}_{CL} \\ {P}_{IA}\end{matrix} \} & [ dB m ]\end{matrix} \qquad Equation 15$$

where P_{IA} is used to denote a new constraint on the transmit power as a function of both the maximum tolerable interference imposed on RP(s) and the estimated interference imposed on RP(s).

The procedure for calculating P_{IA} (e.g., estimating interference towards RP against the maximum tolerable interference) may involve the use of pre-configured information from the network on the RP nodes (e.g., positioning information) in the vicinity of the terminal. In one example the WTRU may calculate P_{IA} as the ratio of the pre-defined maximum tolerable interference imposed on RP(s) over the relative path-loss dependent distance to the RP(s). This approach would not require acquiring instantaneous or short term channel information. In one example the network may configure the terminal with a list of RP positions such that the terminal may perform vicinity-aware interference management.

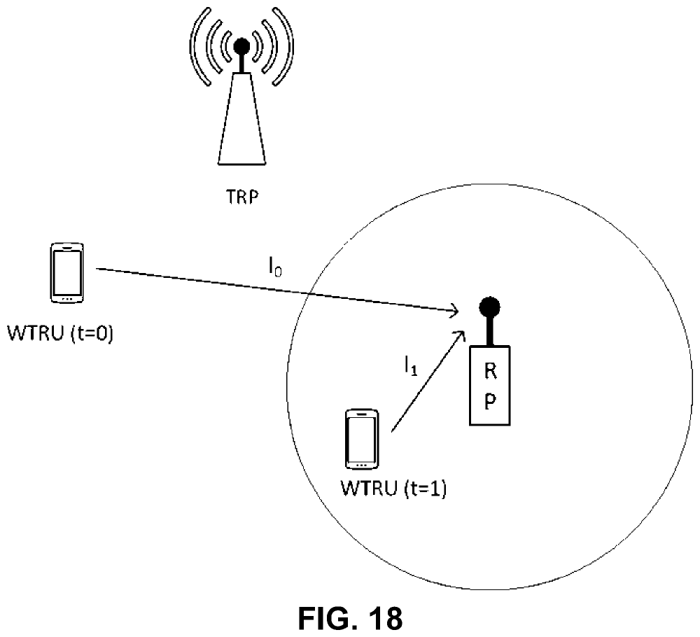

Interference-aware power control is illustrated in FIG. 18. In this example, the network may provide the WTRU with certain information regarding the position of the RP node. A threshold based on the maximum allowed interference towards the RP node also may be provided to the WTRU by the network. The WTRU at certain intervals for updating its uplink power control coefficient may calculate and take into account the estimated interference (It at time t) towards the RP and may compare this to the set threshold. In this example, for the WTRU at t=0, I₀ falls below the set threshold, hence power control equation at this time follows from the conventional procedure, P_{TxUL}=min(P_{CMAX}, P_{C}). The WTRU at t=1, on the other hand, has moved closer to the RP such that if the conventional power control mechanism was to be used the estimated interference would exceed the tolerable threshold. In this case, the proposed interference-aware UL power control mechanism (eqn. 15) is used P_{TxUL}=min(P_{CMAX}, P_{C} P_{IA}) to avoid excessive interference from the UE towards the RP.

One exemplary approach to enhance open-loop power control is to consider the impact of the coefficient for fractional open-loop power control, a. In state-of-the-art systems, 0≤α≤1. It can be seen from Equation 1 that α=1 results in that the UE fully compensates for increased estimated pathloss from the TRP that transmitted the corresponding PL RS. A value 0<α<1 only partly compensates for increased estimated pathloss, typically resulting in decreased (open-loop based) received power at the TRP with increased pathloss to the UE. A value α=0 results in the disabling of the open-loop power control, since the estimated pathloss doesn't impact the UL transmit power.

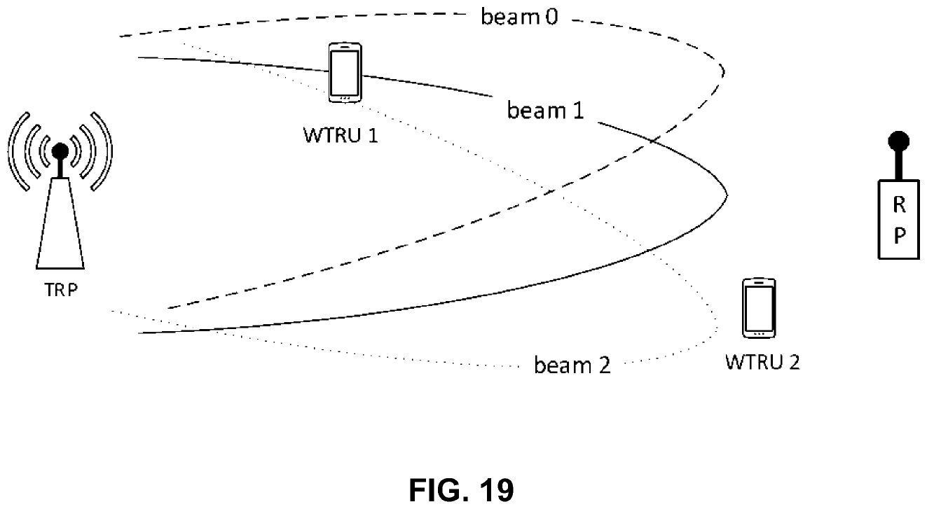

Now consider an exemplary scenario as in FIG. 19. A set of three PL RS are transmitted by a TPR using three beams (a PL RS transmitted using a beam). For WTRU 1, the strongest beam (of the three, beam 0, beam 1, beam 2, considered here) is beam 0. Furthermore, since WTRU 1 is close (small PL) to the TRP, RSRP₀ (the WTRU-measured RSRP of PL RS 0 transmitted on beam 0) is high. However, RSRP₂ may be low for WTRU 1, due to beam 2 misalignment.

For WTRU 2, the strongest beam (of the three considered here) is beam 2. However, since WTRU 2 is far (large PL) from the TRP, RSRP₂ (the WTRU-measured RSRP of PL RS 2 transmitted on beam 2) is quite low. The RSRPs for the other two PL RS are even lower, due to beam misalignment (beam 0 and beam 1). In such a scenario, it may be beneficial to have WTRU 1 follow legacy open-loop power control, adapting its transmit power depending on the pathloss to/from the TPR. For WTRU 2, on the other hand, it may be beneficial to have it use lower transmit power than it would have using pathloss compensation based on a pathloss estimated from PL RS 2.

Hence, following the discussion in the example above, a WTRU may, for example, use [symbol] a first power control method, e.g., legacy power control, if [symbol] (RSRPⱼ)<Tₖ, where k is the index of the PL RS with highest RSRP, i.e. k=arg [symbol] (RSRPⱼ), and Tₖ is a threshold that may be configurable or fixed. The threshold may be different or the same for different k. If [symbol] (RSRPⱼ)≥Tₖ, the WTRU may use a second power control method.

In some cases, e.g., if different PL RS are transmitted with different power, it may be more suitable to use the estimated pathloss instead of the estimated RSRP. In other words, a first power control method may be used if min_{j∈} [symbol] (PLⱼ)<Tₖ, where k is the index of the PL RS with the lowest PL estimate PLⱼ, which may for example be computed as PLⱼ=P_{TxDL,j}−RSRPⱼ.

The set [symbol] may include monitored PL RS indices that the WTRU may use in this power control scheme. In some cases, [symbol] is a subset of or equals [symbol] . In some cases, [symbol] is a subset of or equals [symbol] . In some cases, [symbol] is a subset of PL RS (indices) that are transmitted from the same TRP.

The first power control method, e.g., to be used closer to the TRP, may comprise, for example, a first target received power and a first value of α, e.g., 0≤α≤1. The second power control method, e.g., to be used closer to the RP, may comprise, for example, a second target received power and a second value of α, e.g., α=0 or a negative value of α.

In the case of α=0, the OL PC may be disabled near the RP. Since pathloss compensation is disabled, the second target received power may be higher than the first target received power. In the case of a negative value of a, e.g. −1≤α<0, the WTRU may reduce its transmits power with increased pathloss to the TRP. In some cases, a power control method with negative α may be configured without the use of a threshold Tₖ, as discussed above, and without a first and second power control method. In some cases, the negative value of a (e.g., in second power control method) has the same magnitude as the positive α (e.g., in the first power control method).

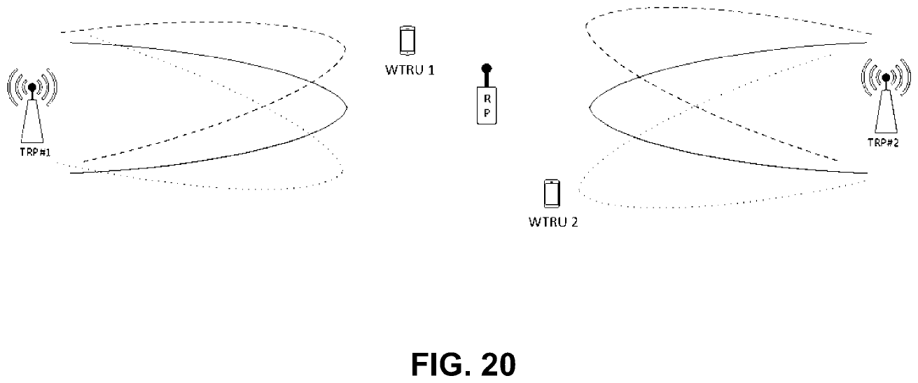

The scheme with negative α may work well for a WTRU between the TRP and the RP. However, if the RP is between the TRP and the WTRU, the WTRU UL transmit power may be too low, due to the negative compensation for pathloss. In a deployment where RPs are placed roughly between TRPs (in terms of PL), this scenario may be addressed by having [symbol] include PL RSs from the TRP with lowest PL, as illustrated in FIG. 20. As depicted in FIG. 20, the solid/dashed/dotted lines represent different beams that are used to transmit the different PL RSs. The shape of the line represents the beamforming gain in a certain angular direction from the TRP. The “peak” of the beam/line (farthest from the TRP) represents the angle with highest beamforming gain. WTRU 1 may use a first set [symbol] ₁, comprising PL RS (indices) transmitted by TRP #1. WTRU 2 may use a second set [symbol] ₂, comprising PL RS (indices) transmitted by TRP #2. If WTRU 1 for example moves further to the right, WTRU 1 may start to use a second set [symbol] ₂ instead.

The set switching could, for example, be achieved by having the WTRU compare a first metric, e.g., a measurement or estimate, based on PL RS in a first set [symbol] ₁ with a second metric based on PL RS in a second set [symbol] ₂. If the first metric plus an optional offset is greater than the second metric, the WTRU may use the first set. Otherwise, the WTRU may use the second set. The offset, which may be zero or non-zero, may be configurable or fixed. A metric may for example be [symbol] (RSRPⱼ) or in [symbol] (PLⱼ). For instance, using the former, a WTRU may use the first set [symbol] ₁ (for power control) if:

$${max}_{j ∈ {𝒟}_{1}} ( {RSRP}_{j} ) + offset > {max}_{j ∈ {𝒟}_{2}} ( {RSRP}_{j} ) \qquad Equation 16$$

Else, the WTRU may use the second set [symbol] ₂. The offset may be used to handle the scenario when the RP is closer to one of the TRPs. In the example above, if the offset is positive, WTRU 1 may switch earlier to TRP #2-based operation (e.g., based on [symbol] ₂).

Even though examples above have considered scenarios with two TRPs, the schemes are applicable to more than two TRPs. For instance, a WTRU may select a set [symbol] ₘ based on that a metric (plus an offset in some cases) is the highest/smallest for the m^{th} set. In this case, an offset may be configured per set [symbol] (e.g., per TRP).

An alternative to the enhanced open-loop power control based on RP RSRP signatures and virtual PL PS may comprise open-loop power control based on positioning. In some cases, a WTRU, TRP, or RP may estimate its position based on positioning RS (PRS) transmitted by TRPs. In some cases, a WTRU, TPR, or RP may perform measurements based on PRS, report the measurement results to the network, or to a particular network node, that estimates the position based on the reported measurement results. Positioning also may be based on signals received by TRPs, e.g., SRS transmitted by a WTRU. The positioning of a TRP also may be based on the transmission of SRS by a TRP. In some cases, positioning of a WTRU, TPR, or RP may be based on GPS or a similar satellite-based positioning technology.

Based on a positioning technology, an estimated position of an RP (POS_{RP}), in a coordinate system, may be known to the network. Based on a positioning technology, a WTRU may estimate its position (POS_{UE}), in the same coordinate system as the RP position.

An alternative PL estimation may be based on the estimated difference in position between the WTRU and the RP, shown in Equation 17.

$$\begin{matrix}\overline{PL} = g ( d ) & [ dB ]\end{matrix} \qquad Equation 17$$

where
P̅L̅ is an enhanced pathloss estimate.
g(.) is a function, with an example given below.
d is the difference (or magnitude thereof) in estimated position between the UE and RP, e.g., d=∥POS_{UE}−POS_{RP}∥, with unit for example metres, degrees of an arc, etc., depending on the spatial reference system.
POS_{UE} is the UE position.
POS_{RP} is the RP position.

An example function g(.) is given below.

$$\begin{matrix}\overline{PL} = {PL}_{0} + 10 γ {log}_{10} \frac{d}{{d}_{0}} & [ dB ]\end{matrix} \qquad Equation 18$$

where
PL₀ is a pathloss at a reference distance.
d₀ is the reference distance, in the same unit at d.
γ is a pathloss exponent, with a typical value between 1 and 4.

The values of one or more of PL₀, d₀, and γ that the WTRU may apply may be configurable by the network. In other cases, the values may be predefined. The position of an RP (POS_{RP}) may be configured by the network to the WTRU, e.g., in a power control configuration.

The use of a positioning based OL PC scheme may be associated with a PL RS index, e.g., an index of a virtual PL RS. In this way, the network may dynamically or semi-statically switch the WTRUpower control between regular OL PC, e.g., towards a TRP, and positioning-based OL PC, e.g., towards an RP.

An example WTRU procedure may follow FIG. 14. At step 1402, the WTRU may receive a configuration of power control, e.g., including configuration of PL RSs, virtual PL RSs, and RP positions. This step also may include the configuration of positioning-based power control. In some cases, positioning-based power control may be activated/deactivated, e.g., by a MAC CE. When configured or activated, the WTRU may be expected to track its own position (e.g., POS_{UE}) to enable position-based OL PC. At step 1404, the WTRU may receive a configuration, activation (e.g., by MAC CE), and/or indication (e.g., by DCI), of a PL RS index for an UL transmission. This means that the PL RS (virtual or not virtual) corresponding to the index shall be used for OL PC for the UL transmission. At step 1406, the WTRU may determine if the PL RS index in the previous step corresponds to a regular (e.g., not virtual) PL RS or to a virtual PL RS. The PL RS index may correspond to a virtual PL RS, e.g., if it is equal to a configured virtual PL RS index. Otherwise, the PL RS index may correspond to a configured index of a regular PL RS. At step 1408, if the PL RS index at step 1402 corresponds to a configured index of a virtual PL RS, e.g., a virtual PL RS index, the WTRU may use an enhanced OL PC procedure, e.g., a positioning-based OL PC procedure. At step 1410, if the PL RS index at step 1402 corresponds to a configured PL RS index, the WTRU may use a regular OL PC procedure.

As a WTRU moves about the network, both TRPs and RPs may measure the signals transmitted by the WTRU, as well as those transmitted by other WTRUs. During periods when the WTRU is closer to a TRP than to an RP, it may be suitable to have the WTRU use regular OL PC. However, as a WTRU approaches an RP, it may be suitable to no longer adjust the UL transmit power due to updated pathloss estimates.

One way to achieve this is to turn off the OL PC, e.g., by setting α=0. However, this may result in an abrupt and usually big drop in WTRU transmit power. An alternative, that may provide a smoother power control, is to freeze its OL PC power offset. In other words, when indicated by the network, the WTRU may record the current value of αPL and keep using the recorded value, even though the WTRU may perform new measurements on PL RSs. Upon freezing the OL PC power offset, the network and WTRU may rely on closed-loop power control (CL OL) for UL transmissions. The WTRU may also be indicated by the network to resume OL PC.

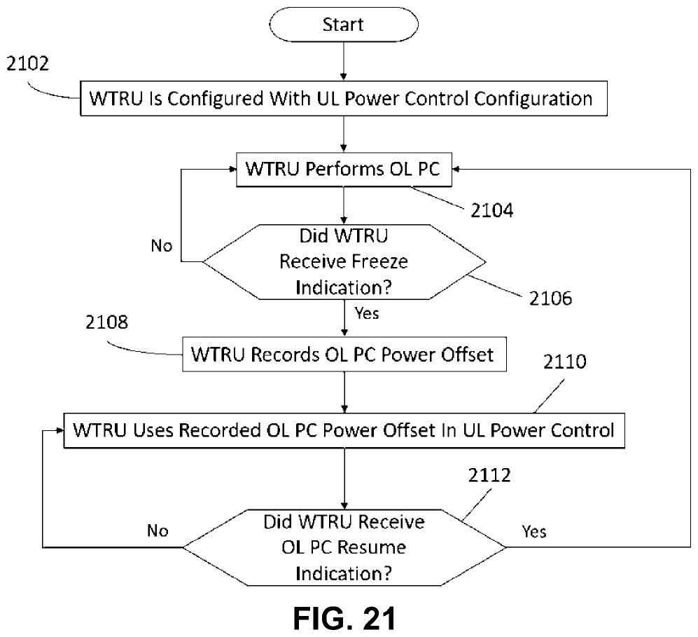

An exemplary WTRU procedure is illustrated in FIG. 21. At step 2102, the WTRU may be configured with UL power control. This may include the configuration to use OL PC freeze functionality. At the second step 2104, the WTRU may perform OL PC, which may include estimation of RSRP of monitored PL RS, PL estimation, computation of OL PC power offset, etc. At the step 2106, the WTRU may evaluate if it received a freeze indication. If so, the process may proceed to step 2108. If not, the process may return to OL PC operation at step 2102. At step 2108, the WTRU may record the OL PC power offset. This may be for example the offset at the time of reception of the freeze indication or the offset some time after the reception, e.g., at the time of the decoding of the indication. At step 2110, the WTRU may use the recorded OL PC power offset in the UL power control, even if the WTRU may have updated RSRP measurement results for PL RS(s). At step 2112, the WTRU may evaluate if it received an indication to resume OL PC. If so, the process may return to step 2102. If not, the WTRU may continue with the recorded OL PC offset at step 2110. The freezing indication, power offset recording, resume indication, etc., may be per UL BWP, per serving cell, per PL RS, per monitored PL RS, or per closed-loop process.

In one example, if the functionality is per PL RS, OL PC may be frozen for a first PL RS, but not frozen for a second PL RS. In another example, if the functionality is per closed loop process, OL PC may be frozen for a first closed loop process, but not frozen for a second closed loop process. This may imply that the WTRU records multiple OL PC power offsets upon reception of a freeze indication for a closed loop process, for example the power offsets corresponding to the PL RS associated with the closed loop process.

Examples of a OL PC freeze indication and OL PC resume indications are discussed below. In one case, an OL PC freeze indication and/or OL PC resume indication is received in a DCI. For example, a parameter in a DCI, e.g., a bit, may indicate freeze state or no freeze state. In other words, a WTRU may record OL PC power offset(s) upon seeing the parameter value, e.g., bit value, change from no freeze state to freeze state in subsequent DCIs. Similarly, the WTRU may be indicated to resume OL PC upon seeing the parameter value change from freeze state to no freeze state in subsequent DCIs.

An existing parameter in a DCI may be used to indicate freeze state or no freeze state, e.g., by associating different parameter values to freeze state or no freeze state. Examples of such existing parameters may be a SRS resource indicator, closed loop index, TPC command, or the like.

In various examples, an OL PC freeze and/or resume indication may be received in a MAC CE. A MAC CE may be used for enhanced closed-loop power control. A MAC CE may be used for either or both of OL PC freeze/resume and enhanced CL PC (MAC CE based closed loop power control).

A MAC CE may include one or more of the following.
Serving cell index
UL BWP index (of the serving cell)
PL RS, e.g., a configured PL RS index, index of a virtual PL RS or an index among monitored PL RS
   May be in the form of an index value or bit map, where a bit corresponds to a PL RS
For an indicated PL RS, additional information may be provided, including one or more of the following.
   Indication of OL PC freeze, e.g., explicit or implicit indication
   Indication of OL PC resume, e.g., explicit or implicit indication
   Closed-loop power offset
A closed-loop power control process, e.g., through an index or a bitmap
For an indicated closed-loop power control process, a closed-loop power offset

In some cases, the indication of OL PC freeze or resume may be implicitly indicated. For instance, the inclusion of a PL RS in the MAC CE may indicate OL PC freeze, while the exclusion may indicate OL PC resume.

In one example, an indicated closed-loop power offset in the MAC CE may correspond to an absolute offset, e.g., the value of P_{CL} in Equation 1. In another example, the indicated closed-loop power offset may be used with accumulation, i.e., it may be added to a previous sum of power control offsets, e.g., TPC commands received in DCI(s) and/or TPC commands received in previous MAC CEs. The mode (e.g., absolute or accumulated power offset) used for the MAC CE based CL PC may be the same as for DCI based CL PC. In some cases, the mode may be separately configured for MAC CE based CL PC.

In one example, a CL power offset value may correspond to OL PC freeze. In one example, a CL power offset value may correspond to OL PC resume. In one example, a CL power offset value may correspond to a reset of an accumulated CL power offset, e.g., the accumulated sum is set to zero.

A benefit of MAC CE based closed loop power offset indication, compared to DCI based, may be a greater value range. In some cases, a WTRU may maintain a closed-loop power control value/offset per PL RS (e.g., configured PL RS, monitored PL RS, PL RS configured or monitored for PUSCH, virtual PL RS). A power control value/offset maintained for a PL RS may be denoted PL RS loop. In some cases, a WTRU may maintain a closed-loop power control value/offset per closed loop process. In some cases, a PL RS may be associated with one or more closed loop processes. A PL RS loop and/or closed loop process may be indicated in a DCI, e.g., a DCI scheduling an UL transmission. If a WTRU maintains a PL RS loop for a PL RS and a closed loop process associated with the PL RS, for a PL RS that is to be used for an UL transmission, the WTRU may add the power offset for the closed loop process with the power offset for the PL RS loop to obtain the total closed loop power offset.

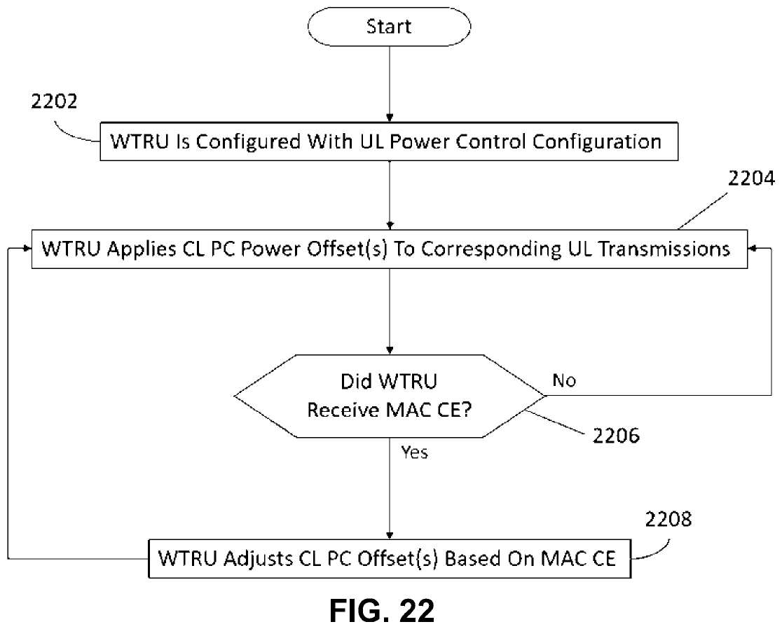

An exemplary WTRU procedure is illustrated in FIG. 22. At 2202, the WTRU may be configured with an UL power control configuration. This may include a configuration to use MAC CE based closed-loop power control. At step 2204, the WTRU may apply CL PC power offset(s) to corresponding UL transmissions, e.g., according to examples discussed herein. At step 2206, the WTRU may determine if it received a MAC CE for closed-loop power control. If so, the process may proceed to step 2208. If not, the WTRU may continue to use the CL PC power offset(s), when applicable, at step 2204. At step 2208, the WTRU may adjust CL PC power offset(s) based on the information in the MAC CE. After this has been done, the adjusted CL PC power offset(s) may be used in subsequent transmissions, at step 2202. Note that FIG. 22 does not show a DCI-based power control loop. However, as discussed above, if a DCI-based power offset indication (e.g., TPC command) is used as well, the DCI-indicated offset and MAC CE-indicated offset may be added to obtain a total CL PC power offset, to be used for corresponding UL transmissions.

State-of-the-art systems may use CL PC as a means to quickly adjust the UL transmit power in relation to the transmit power level offered by the OL PC. One mode of operation is to accumulate power offsets received in TPC commands during a certain time window, to obtain a total CL power offset. Hence, TPC commands received prior to the start of the time window may be excluded. In a system without OL PC, or with a less accurate OL PC, it may be beneficial to enhance the CL PC to offer more flexible accumulation of historic power control commands.

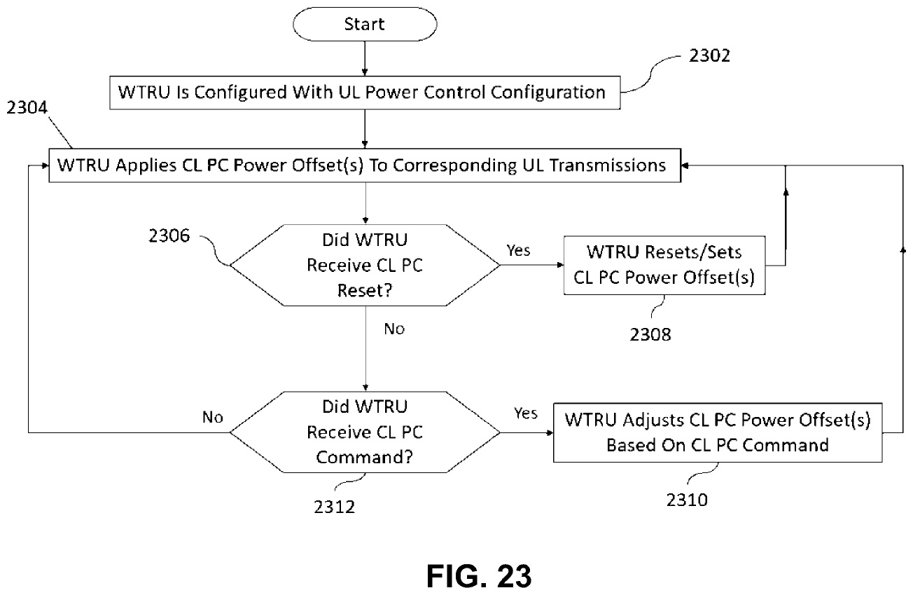

In one approach, closed loop power offsets, e.g., in TPC commands and/or MAC CEs, are accumulated until an indication to stop or to reset the accumulation is received. An exemplary procedure is shown in FIG. 23. At step 2302, the WTRU may be configured with an UL power control configuration. This may include a configuration to use the long-term closed-loop accumulation described herein. At step 2304, the WTRU may apply CL PC power offset(s) to corresponding UL transmissions, e.g., according to examples discussed herein. At step 2306, the process may proceed to step 2308 if a CL PC reset/set indication is received. Otherwise, the process may proceed to step 2312. A CL PC reset or set indication may be carried in a DCI, a MAC CE, or in an RRC reconfiguration. At step 2312, the process may proceed to step 2310 if a CL PC command is received. Otherwise, the process may return to step 2302. A CL PC command may include CL PC power offset(s). A CL PC command may be carried in a DCI, e.g., a TPC command, or a MAC CE, e.g., as discussed herein. At step 2308, the WTRU may reset one or more accumulation sums to a predefined value, e.g., 0 dB, or sets one or more accumulation sums to one or more values. The value(s) may be indicated in the CL PC reset/set indication.

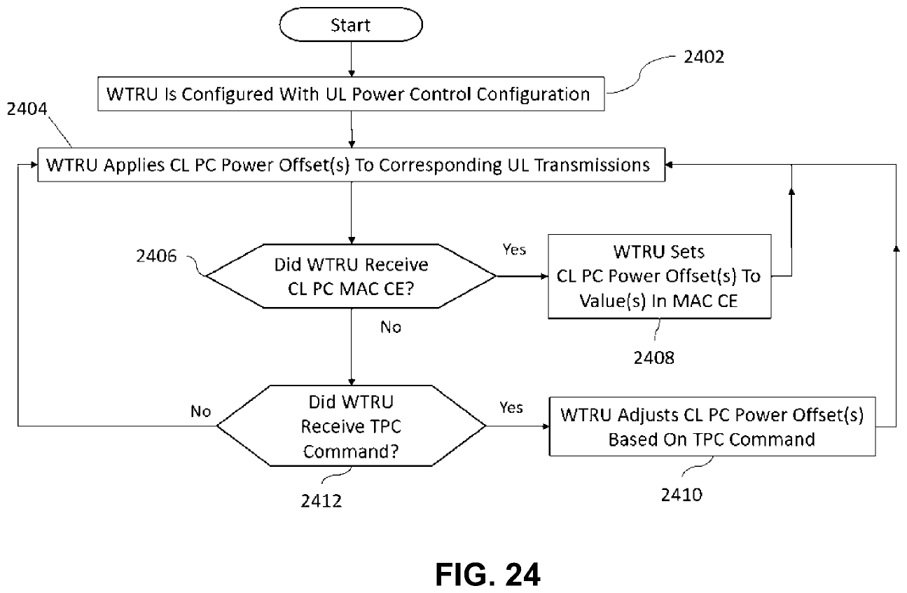

In one example, a MAC CE may carry CL PC information for one or more closed loop processes, and/or PL RS loop(s), e.g., as described herein. The CL PC information includes a CL PC power offset value, e.g., an absolute power offset value, for each of the indicated CL processes and/or PL RS loops. Upon reception, the WTRU may discard the accumulated sums for the indicated CL processes and/or PL RS loops, and instead sets the sums to the corresponding indicated CL PC power offset values. Subsequent power offsets received in TPC commands may be added to the newly set value. An exemplary illustration of a WTRU procedure is shown in FIG. 24.

Steps 2402 and 2404 of FIG. 24 may be similar to steps 2302 and 2304 of FIG. 23. At step 2406 of FIG. 24, the process may proceed to step 2408 if a CL PC MAC CE is received. Otherwise, the process may proceed to step 2412. At step 2412, the process may proceed to step 2410 if a TPC command is received, e.g., in a DCI. Otherwise, the process may return to step 2402. At step 2408, the WTRU may set one or more accumulation sums to one or more values carried in the MAC CE.

A benefit of combining DCI based and MAC CE based CL PC is that DCI based accumulation may provide frequent, but small power adjustment, while the MAC CE based power offset indication may provide less frequent, but larger power adjustments. A MAC CE may also provide adjustments to CL PC processes or PL RS loops that have not been adjusted by DCI recently, e.g., so that they are more up to date.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods, apparatuses, and articles of manufacture, within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

Although foregoing embodiments may be discussed, for simplicity, with regard to specific terminology and structure, (e.g., radio frequency (RF), microwave, centimeter wave, micrometer wave, infrared (IR), ultraviolet (UV), visible light, etc.), the embodiments discussed, however, are not limited to thereto, and may be applied to other systems that use other forms of electromagnetic waves or non-electromagnetic waves such as acoustic waves, for example.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis, or the like, or any appropriate combination thereof. As another example, when referred to herein, the terms “user equipment” and its abbreviation “UE”, the term “remote” and/or the terms “head mounted display” or its abbreviation “HIMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media, which are differentiated from signals, include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of methods, apparatuses, articles of manufacture, and systems provided above are possible without departing from the scope of the invention. In view of the wide variety of embodiments that can be applied, it should be understood that the illustrated embodiments are examples only, and should not be taken as limiting the scope of the following claims. For instance, embodiments provided herein include handheld devices, which may include or be utilized with any appropriate voltage source, such as a battery or the like, providing any appropriate voltage.

Moreover, in embodiments provided herein, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In example embodiments, several portions of the subject matter described herein may be implemented via Application Specific Integrated Circuits (ASICs), Field Programmable Gate Arrays (FPGAs), digital signal processors (DSPs), and/or other integrated formats. Those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. Those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

### Abbreviations and Acronyms

A/D Analog-to-Digital
AGC Automatic Gain Control
BWP Bandwidth Part
CL Closed Loop
CRAN Centralized RAN
CSI-RS Channel State Information RS
D/A Digital-to-Analog
DAS Distributed Antenna System
DCI Downlink Control Information
DL Downlink
FDD Frequency Division Duplex
FDM Frequency Division Multiplexing
FR1 Frequency Range 1
FR2 Frequency Range 2
GPS Global Positioning System
ID Identity, also index
MAC Medium Access Control
MAC CE MAC Control Element
MCS Modulation and Coding Scheme
MIMO Multiple Input Multiple Output
MPE Maximum Permissible Exposure
MU-MIMO Multi-User MIMO
OL Open Loop
PBCH Physical Broadcast Channel Block
PC Power Control
PL Pathloss
PL RS Pathloss Reference Signal
PRACH Physical Random Access Channel
PRS Positioning RS
PUCCH Physical Uplink Control Channel
PUSCH Physical Uplink Shared Channel
RAN Radio Access Technology
RP Reception Point
RRC Radio Resource Control
RRH Remote Radio Head
RS Reference Signal
RSRP RS Received Power
SCell Secondary Cell
SDM Spatial Division Multiplexing
SINR Signal to Interference plus Noise power Ratio
SNR Signal to Noise power Ratio
SRI SRS Resource Indicator
SRS Sounding RS
SSB Synchronization Signal/PBCH Block
SUL Supplemental Uplink
TDD Time Division Duplex
TDM Time Division Multiplexing
TPC Transmit Power Control
TRP Transmission and Reception Point
TRS Tracking RS (also CSI-RS for tracking)
UL Uplink

What is claimed is:

1. A method performed by a wireless transmit/receive unit (WTRU), the method comprising:
receiving configuration information, the configuration information comprising a first set of reference signal received power (RSRP) values associated with a first set of reference signals (RSs) measured at a reception point (RP);
measuring a second set of RSRP values associated with a second set of RSs;
determining a difference between one or more of the first set of RSRP values and one or more of the second set of RSRP values;
determining a pathloss (PL) associated with open-loop (OL) power control (PC) based on the determined difference; and
transmitting an uplink transmission using a power level based on the determined PL.

2. The method of claim 1, further comprising determining the power level based on the determined PL.

3. The method of claim 1, wherein the determined PL comprises an estimated PL between the WTRU and the RP.

4. The method of claim 1, wherein:
the first set of RSRP values comprises a first plurality of RSRP values;
the second set of RSRP values comprises a second plurality of RSRP values; and
the first plurality differs from the second plurality.

5. The method of claim 1, further comprising receiving the second set of RSs from a plurality of transmission and reception points (TRPs).

6. The method of claim 1, further comprising monitoring a subset of the first set of RSs associated with the received first set of RSRP values, wherein the second set of RSs comprises the subset of the first set of RSs.

7. The method of claim 6, further comprising receiving an indication of the subset from at least one of downlink control information (DCI), a medium access channel control element (MAC CE), or a radio resource control (RRC) configuration.

8. The method of claim 1, further comprising receiving at least one of the second set of RSs via a synchronization signal physical broadcast channel block (SSB), a channel state information reference signal (CSI-RS), a tracking RS (TRS), or a position RS (PRS).

9. A wireless transmit/receive unit (WTRU) comprising;
a transceiver; and
a processor, the WTRU configured to:
receive, via the transceiver, configuration information, the configuration information comprising a first set of reference signal received power (RSRP) values associated with a first set of reference signals (RSs) measured at a reception point (RP);
measure a second set of RSRP values associated with a second set of RSs;
determine a difference between one or more of the first set of RSRP values and one or more of the second set of RSRP values;
determine a pathloss (PL) associated with open-loop (OL) power control (PC) based on the determined difference; and
transmit, via the transceiver, an uplink transmission using a power level based on the determined PL.

10. The WTRU of claim 9, further configured to determine the power level based on the determined PL.

11. The WTRU of claim 9, wherein the determined PL comprises an estimated PL between the WTRU and the RP.

12. The WTRU of claim 9, wherein:
the first set of RSRP values comprises a first plurality of RSRP values;
the second set of RSRP values comprises a second plurality of RSRP values; and
the first plurality differs from the second plurality.

13. The WTRU of claim 9, further configured to receive, via the transceiver, the second set of RSs from a plurality of transmission and reception points (TRPs).

14. The WTRU of claim 9, further configured to monitor, via the transceiver, a subset of the first set of RSs associated with the received first set of RSRP values, wherein the second set of RSs comprises the subset of the first set of RSs.

15. The WTRU of claim 14, further configured to receive, via the transceiver, an indication of the subset from at least one of downlink control information (DCI), a medium access channel control element (MAC CE), or a radio resource control (RRC) configuration.

16. The WTRU of claim 9, further configured to receive, via the transceiver, at least one of the second set of RSs via a synchronization signal physical broadcast channel block (SSB), a channel state information reference signal (CSI-RS), a tracking RS (TRS), or a position RS (PRS).

17. The WTRU of claim 9, further configured to determine the power level based on the WTRU being within a vicinity of the RP.

18. (canceled)

19. The method of claim 1, further comprising determining the power level based on the WTRU being within a vicinity of the RP.
